(19) United States
(12) Patent Application Publication
(10) Pub. No.: US 2018/0025452 A1
(43) Pub. Date: Jan. 25, 2018

(54) COMPUTERIZED SYSTEMS AND METHODS FOR OPTIMIZING BUILDING CONSTRUCTION

(71) Applicant: Realtex Value LLC, San Francisco, CA (US)

(72) Inventors: BORIS FADEEV, San Francisco, CA (US); ALISA CHEBOTARYOV, San Francisco, CA (US); SERGEY TIKHOMIROV, Moscow (RU); TOMAS JANIK, San Francisco, CA (US); CODY FORNARI, Hollister, CA (US)

(21) Appl. No.: 15/215,731

(22) Filed: Jul. 21, 2016

(51) Int. Cl. G06Q 50/16

(52) U.S. Cl. CPC G06Q 50/165

(57) ABSTRACT

Computerized systems and computer-implemented methods are provided for selecting a “lot” of land for use in a development project, identifying available development options for the lot, identifying a substantial number of development schemes with each of the development options, assembling a computer-based construction model for each of the development options, transforming the computer-based construction model into a computer-based optimization model that maximizes profit by optimizing revenue and development cost for each development option, determining a maximum land value for each development option by establishing a minimum expected return, and determining a land value based on the set of maximum land values for the development options. The computerized systems and computer-implemented methods provided herein computationally optimize the cost-related parameters and revenue-related parameters in order to maximize profit from the development project and determine a value for the lot based on a minimum expected return from the development project.

### BACKGROUND

### Field of the Invention

The teachings are directed, generally, to computerized systems and computer-implemented methods for optimizing a building construction by pursuing the highest net earnings from a potential development project through a computer-implemented optimization of the cost-related parameters and revenue-related parameters to maximize profit from the development project.

### Description of the State-of-the-Art

Computational optimization deals with solving known optimization problems that cannot be solved analytically using algorithms implementing numeric computing techniques deployed on computer platforms. Specifically, computational optimization uses algorithms that terminate in a finite number of steps, or iterative methods that converge to a solution (on some specified class of problems), or heuristics that may provide approximate solutions to optimization problems.

One of the known optimization problems in the area of real estate development is to realize, in a real estate development project, the highest net earnings possible, which involves selecting the best combination of land and project. This is currently done, to a large extent, “manually” in a predesign phase of a development project, a slow process that sets-forth serious limitations on the information available for use in identifying the right combination of land and project. Unfortunately, the problem of selecting the best combination of land and project has no easy analytical (e.g. “manual”) solution. This is where the aforesaid computational optimization techniques come into play.

The right combination of land and project should fit the criteria of a “highest and best use”, meaning that it is (i) legal, in that it meets the zoning and building code requirements; (ii) physically possible, in that what is proposed can, in fact, be developed using available construction and engineering methods; (iii) economically feasible, in that it can be done within budget; and (iv) believed to have the highest net earnings.

The amount that should be paid for a “lot” of land is a substantial factor in determining the economic feasibility of a development project. The most common approach is to compare sale prices of similar lots, which unfortunately introduces a large potential error by not taking into account how the price of the land fits into a feasibility study. For example, the comparables approach doesn't account for the high number of construction parameters involved in the cost of the development project, or how the choice of development project affects the potential revenue. Each development option is defined by a combination of construction parameters that define the actual cost of the project and the potential revenue that might be obtained from the project. In order to determine a price for the lot, these factors should be taken into account. Some have suggested the use of a “residual land value” calculation which makes an attempt to factor development costs into a land value estimate, but such calculations also introduce significant error through the use of a comparison approach as follows: estimating the cost of the development project using comparables while leaving the land value as an unknown “residual” amount; estimating a projected revenue from the development project; and, back-calculating the estimated, unknown “residual” land value by establishing a minimum desired profit from the project. One problem with this approach is that it doesn't account for the high number of permutations in possible project designs, each permutation of which affects development cost and potential revenue, which are generally limited, for example, by legal requirements that include the zoning codes, zoning restrictions, and building codes that govern the use of the lot. Another problem is that professional appraisers, even if asked to attempt such a calculation, will not try without the project already having an entitlement for the project granted by local authorities, or other proof that the project complies with legal requirements, which will most likely be long after the feasibility study is complete.

The relationship between project design, development cost, and revenue makes things even more complicated, as each of the permutations in the project design can, rather unpredictably, change the profit that may be realized from the project; and, as a result, the amount that should be paid for the lot. For example, one development option might be a low cost single-story warehouse using low end materials, a simple design, and minimal utilities; and, another development option might be a high cost multi-story executive office building using high end materials, a complex design, and a vast array of utilities and amenities. Moreover, to add even more complexity, the effects of these potential changes in project design on the development costs, potential revenue, and expected profit also include a time dependency, such that the time to complete the project can affect the feasibility of the project, as well as the maximum amount that should be paid for the lot.

For at least the above reasons, a single analysis is currently used as the basis for deciding whether to acquire a development project. The process typically includes relying on a trusted professional having the experience and skill needed to help initially select the best project. This means that the professional will “subjectively” use experience and skill to choose a development project for a feasibility study, and then estimate the potential revenue, development cost, and comparable land values for that one project. As such, the feasibility study includes possible human error and takes considerable time and expense, the combination of which seriously affects the scope and accuracy of the study. Moreover, the single analysis of one option cannot be viewed with confidence as an accurate indicator that the project has the highest possible net earnings among all available development options.

One of skill knows that, in order to determine the “maximum” of anything, a sufficient amount of data should be collected for analysis. As such, determining the highest net earnings from available development options should, in any event, include comparing a substantial number of development schemes within each of the development options, the results of which create a “distribution” of data having such a “maximum” within the distribution. Moreover, since the each of the development options will have a high number of permutations that result in a high number of development schemes, any process of analyzing a substantial number of those permutations should include a step that identifies the options that will generate the highest net earnings to increase the accuracy of the analysis.

Moreover, current methods of providing a single analysis cannot simply be “repeated” to provide the substantial number of development schemes within each of the development options. In theory, the single “subjective” process could be repeated, but the time required will limit the repeats to most likely not more than a few times and by no more than a few architects. One of skill will appreciate that such limited data is clearly insufficient to suggest a development scheme that would represent the highest net earnings with any reasonable expectation of accuracy, as the level of confidence in the prediction would be unacceptably low. As such, the scope of such a repeated analysis would be limited by at least time, in any event, and the accuracy would be relatively immeasurable in many cases. This is because, rather than basing the selection of a development option on an analysis of a substantial number of development schemes, each architect's selection of development project is subjectively based on a unique set of personal experiences and bias rather than the true economics and profitability that exists, yet remains uncovered, among the many development options and schemes possible for the lot. For at least the above reasons, the task of obtaining a useful distribution of data would be virtually impossible using current methods.

There is currently no tool that can be used to review a substantial number of development schemes within each of the development options to identify, with reasonable accuracy, the development project having the highest net earnings, much less a tool that could hope to do so in a reasonable amount of time, much less a tool that also identifies the development options most likely to produce the highest net earnings by selecting a combination of cost-related parameters and revenue-related parameters that optimize development costs and revenue to maximize profit. Having such a tool allows a person of skill in the art to determine a maximum land value that should not be exceeded if a preselected minimum financial return is to be realized.

Accordingly, and for at least the above reasons, one of skill in the art will appreciate having the systems and methods provided herein that perform a complex series of data transformations to (i) identify a set of available development options for a select, lot of land using a database having zoning codes, zoning restrictions, building codes, and the like, for the select, lot of land; (ii) identify at least a substantial number of development schemes within each of the available development options; (iii) maximize profit by identifying optimum cost-related parameters and optimum revenue-related parameters within the available development options; and, (iv) determine a land value by (a) establishing a minimum financial return needed for the development project to be economically feasible, (b) determining a maximum land value that should be paid for each development option based on the minimum financial return needed, and/or (c) assessing the relative maximum land values for each development option to determine the value of the lot.

### SUMMARY

State-of-the-art methods for determining the value of a lot of land for use in a development project are generally limited to an estimate that uses a simple comparables approach. With regard to feasibility analyses that would take into account such an estimate, current state of the art methods include (i) performing a “predesign phase” of typically a single, “select” development project and (ii) producing an estimated profit for the single, select project, each of which merely provides information that is subjective to the single, select development project. Since the process is costly and time-consuming, it is rare to look into more than one development option in this manner, although sometimes it will be done, perhaps, for a couple of, and maybe even a few, select development options. As stated above, one of skill in the art will appreciate having the systems and methods provided herein that perform a complex series of data transformations to (i) identify a set of available development options for a select, lot of land using a database having zoning codes, zoning restrictions, building codes, and the like, for the select, lot of land; (ii) identify at least a substantial number of development schemes within each of the available development options (iii) maximize profit by identifying optimum cost-related parameters and optimum revenue-related parameters within the available development options; and (iv) determine a land value by (a) establishing a minimum financial return needed for the development project to be economically feasible, (b) determining a maximum land value that should be paid for each development options based on the minimum financial return needed, and/or (c) assessing the relative maximum land values for each development option to determine the land value.

As such, systems and methods are provided for selecting a “lot” of land for use in a development project, identifying a substantial number of schemes within each of the development options for the lot, assembling a construction model for each of the development options, transforming the construction model into an optimization model that maximizes profit by optimizing revenue and development cost for each development option, determining a maximum land value for each development option by establishing a minimum expected return, and determining a land value based on the set of maximum land values for the development options. The systems and methods provided herein computationally optimize the cost-related parameters and revenue-related parameters in order to maximize profit from the development project and determine the value for the lot based on a minimum expected return from the development project.

The teachings are directed to systems and methods for pursuing the greatest net earnings from a development project by computationally optimizing the cost-related parameters and revenue-related parameters in order to maximize profit from the development project and determine a value for a lot of land. Methods and systems are provided for determining a land value by computationally optimizing a series of development options. Generally speaking, systems and methods involve the steps of selecting (i) a lot of land to determine its value; (ii) identifying development options, Di, for the lot, and assembling a construction model, CMi, for each Di; (iii) transforming the construction model, CMi, into an optimization model, OMi, for each Di; and, (iv) determining a maximum land value, LVmaxi, for each Di to determine a land value for the lot.

In some embodiments, the methods can comprise accessing a computer system having a user interface, a database, a location module, a project module, a predesign module, a computational optimization engine, a revenue module, a cost module, and a financial module, each of which is on a non-transitory computer readable storage medium and operably connected to a processor. The method includes selecting a lot of land with the location module, and identifying a plurality of development options for the lot with the project module. The identifying can include extracting zoning data from the database for the lot, the zoning data including zoning restrictions, and identifying each development option data structure, Di, in the plurality of development options.

The methods further include assembling a construction model, CMi, for each Di with the predesign module, wherein the assembling includes architecting a development scheme substructure of data, (Dx)i, for each Di. The architecting can include, for example, creating a list of restriction parameters obtained from the database for each Di, each restriction parameter in the list used in defining a respective (Dx)i; creating a series of shapes for each Di, the series of shapes composing a respective shape data structure, Si, where a substructure of data, (Sx)i, defines the shape corresponding to the respective (Dx)i; creating a series of floor plans for each Si, the series of floor plans composing a respective floor plan data structure, FPi, where a substructure of data, (FPx)i, defines the floor plan corresponding to the respective (Dx)i; creating a series of building structures for each Di, the series of building structures composing a respective building structure data structure, BSi, where a substructure of data, (BSx)i, defines the building structure corresponding to the respective (Dx)i; and, creating a series of construction material and labor lists for each BSi, the series of construction materials and labor lists composing a respective construction materials and labor list data structure, MLi, where a substructure of data, (MLx)i, defines the construction material and labor list corresponding to the respective (Dx)i; wherein, CMi is a compilation of Si, FPi, BSi, and MLi; i is an integer ranging from 1 to I, where I consists of the number of development options; and, x is an integer ranging from 1 to X, where X consists of the number of development schemes corresponding to the respective Di.

The methods can further include transforming CMi into a respective optimization model, OMi, for the respective Di with the computational optimization engine; wherein, OMi includes a series of functions having (i) a series of revenue-related parameters from CMi generating a total revenue, Ri, over a time, Ti; and, (ii) a series of cost-related parameters from CMi generating a total development cost, DCi, over a time, Ti; wherein Ti ranges from 0 to tin months. The series of functions can include, for example, one or more constraint functions, (CFz)i, where z is an integer ranging from 1 to Z, Z including one or more zoning restrictions for Di; and, an objective function, OFi, Pi=Ri-DCi, where Pi is a profit margin. The transforming can include, for example, establishing a defined revenue domain by executing instructions in the revenue module that set a relationship between the total revenue, Ri, and the series of revenue-related parameters from the construction model, CMi, for the respective Di; establishing a defined cost domain by executing instructions in the cost module that set a relationship between a total development cost, DCi, and, a series of cost-related parameters from the construction model, CMi, for the respective Di; and, maximizing Pi by optimizing (i) the series of revenue-related parameters to identify or estimate Ropti, the optimized Ri for the respective Di; and, (ii) the series of construction-cost-related parameters to identify or estimate DCopti, the optimized DCi for the respective Di; wherein, the optimizing includes (i) assigning the OMi as a type of mathematical model, the assigning including determining whether the constraint functions, (CFz)i, are linear, non-linear, discrete, or a combination thereof; and, determining whether the objective function, OFi, is linear, non-linear, or discrete; (ii) matching an optimization technique to the type of mathematical model assigned; and, (iii) instructing the computational optimization engine to solve for Ropti and DCopti;

The computer-implemented methods can further include calculating the land valuation, LVi, with the computational optimization engine for the respective Di. The calculating can include establishing a minimum return value, MRV, with the financial module; where, the MRV is a measure of return defined by a select, return calculation function, RCF, which can be a function of Ropti, DCopti, LVi, and RCPy; where, RCPy is a set of one or more return calculation parameters for the respective RCF, where y is the number of return calculation parameters in RCP and is an integer ranging from 0 to Y. As such, the calculating can include selecting the RCF, the selecting including setting the RCPy for use in the RCF; determining a maximum land value, LVmaxi, for the respective Di, the determining including maximizing LVi subject to RCF (Ropti, DCopti, LVi, RCPy) MRV; where, the LVmaxi is a maximum price to pay for the land to generate the MRV; and, repeating the determining of LVmaxi for each Di. And, the methods can also include assessing the relative values of LVmaxi for each Di and determining a land value for development of the lot, or parcel, of land.

As such, computerized systems are provided for determining a land value by computationally optimizing a series of development options. The computerized systems can comprise a user interface, a database, a location module, a project module, a predesign module, a computational optimization engine, a revenue module, a cost module, and a financial module, each of which is on a non-transitory computer readable storage medium, are each operably connected to a processor, and each have instructions for execution on the processor.

The modules and engines can include any instruction or combination of instructions to respond to user commands by executing the instruction or combination of instructions through the processor, often using data from the database. For example, the location module can be configured with instructions for executing a selection of a lot of land to obtain data from the database relevant to the lot. The project module can be configured with instructions for executing an identification of a plurality of development options for the lot and, as such, the project module can be configured with instructions for executing an extracting of zoning data from the database for the lot, the zoning data including zoning restrictions that help identify each development option data structure, Di, in the plurality of development options. The predesign module can be configured with instructions for executing an assembling of a construction model, CMi, for each Di with the predesign module, wherein the assembling includes architecting a development scheme substructure of data, (Dx)i, for each Di. The architecting can include, for example, creating a list of restriction parameters obtained from the database for each Di, each restriction parameter in the list used in defining a respective (Dx)i; creating a series of shapes for each Di, the series of shapes composing a respective shape data structure, Si, where a substructure of data, (Sx)i, defines the shape corresponding to the respective (Dx)i; creating a series of floor plans for each Si, the series of floor plans composing a respective floor plan data structure, FPi, where a substructure of data, (FPx)i, defines the floor plan corresponding to the respective (Dx)i; creating a series of building structures for each Di, the series of building structures composing a respective building structure data structure, BSi, where a substructure of data, (BSx)i, defines the building structure corresponding to the respective (Dx)i; and, creating a series of construction material and labor lists for each BSi. It should be appreciated that the series of construction materials and labor lists compose a respective construction materials and labor list data structure, MLi, where a substructure of data, (MLx)i, defines the construction material and labor list corresponding to the respective (Dx)i; wherein, CMi is a compilation of Si, FPi, BSi, and MLi; i is an integer ranging from 1 to I, where I consists of the number of development options; and, x is an integer ranging from 1 to X, where X consists of the number of development schemes corresponding to the respective Di;

The computational optimization engine, likewise, is configured with instructions for executing a transforming of the CMi into a respective optimization model, OMi, for the respective Di. OMi can be configured to include a series of functions having (i) a series of revenue-related parameters from CMi generating a total revenue, Ri, over a time, Ti; and, (ii) a series of cost-related parameters from CMi generating a total development cost, DCi, over a time, Ti; wherein Ti ranges from 0 to tin months. The series of functions can include one or more constraint functions, (CFz)i, where z is an integer ranging from 1 to Z, Z including one or more zoning restrictions for Di; and, an objective function, OFi, Pi=Ri-DCi, where Pi is a profit margin. The transforming can include, for example, establishing a defined revenue domain by executing instructions in the revenue module that set a relationship between the total revenue, Ri, and the series of revenue-related parameters from the construction model, CMi, for the respective Di; establishing a defined cost domain by executing instructions in the cost module that set a relationship between a total development cost, DCi, and, a series of cost-related parameters from the construction model, CMi, for the respective Di; and, maximizing Pi by optimizing (i) the series of revenue-related parameters to identify Ropti, the optimized Ri for the respective Di; and, (ii) the series of construction-cost-related parameters to identify DCopti, the optimized DCi for the respective Di. The optimizing, can include, for example, (i) assigning the OMi as a type of mathematical model, the assigning including determining whether the constraint functions, (CFz)i, are linear, non-linear, discrete, or a combination thereof; and, determining whether the objective function, OFi, is linear, non-linear, or discrete; (ii) matching an optimization technique to the type of mathematical model assigned; and, (iii) instructing the computational optimization engine to solve for Ropti and DCopti.

Knowing Ropti and DCopti, the computational optimization engine can be further configured with instructions for executing a calculating of a land valuation, LVi, with for the respective Di; wherein, the calculating includes (i) establishing a minimum return value, MRV, with the financial module; where, the MRV is a measure of return defined by a select, return calculation function, RCF, which is a function of Ropti, DCopti, LVi, and RCPy; where, RCPy is a set of one or more return calculation parameters for the respective RCF, where y is the number of return calculation parameters in RCP and is an integer ranging from 0 to Y; (ii) selecting the RCF, the selecting including setting the RCPy for use in the RCF; (iii) determining a maximum land value, LVmaxi, for the respective Di, the determining including maximizing LVi subject to RCF (Ropti, DCopti, LVi, RCPy) MRV; where, the LVmaxi is a maximum price to pay for the land to generate the MRV; and, (iv) repeating the determining of LVmaxi for each Di. It should be appreciated that the user interface can be adapted to display the LVmaxi for each Di using any form of display, including but not limited to, text, numbers, audio, and graphics, for example.

Computer-implemented methods are also provided for creating a system of determining a land value by computationally optimizing a series of development options. The methods can include, for example, assembling a computer system with a user interface, a database, a location module, a project module, a predesign module, a computational optimization engine, a revenue module, a cost module, and a financial module, each of which is on a non-transitory computer readable storage medium, is operably connected to a processor, and has instructions for execution on the processor. The methods can also include configuring the location module with instructions for executing a selection of a lot of land to obtain data from the database relevant to the lot; and, configuring the project module with instructions for executing an identification of a plurality of development options for the lot, the project module configured with instructions for executing an extracting of zoning data from the database for the lot, the zoning data including zoning restrictions; and, an identifying of each development option data structure, Di, in the plurality of development options. The methods also include configuring the predesign module with instructions for executing an assembling of a construction model, CMi, for each Di with the predesign module, wherein the assembling includes architecting a development scheme substructure of data, (Dx)i, for each Di.

The architecting can include creating a list of restriction parameters obtained from the database for each Di, each restriction parameter in the list used in defining a respective (Dx)i; creating a series of shapes for each Di, the series of shapes composing a respective shape data structure, Si, where a substructure of data, (Sx)i, defines the shape corresponding to the respective (Dx)i; creating a series of floor plans for each Si, the series of floor plans composing a respective floor plan data structure, FPi, where a substructure of data, (FPx)i, defines the floor plan corresponding to the respective (Dx)i; creating a series of building structures for each Di, the series of building structures composing a respective building structure data structure, BSi, where a substructure of data, (BSx)i, defines the building structure corresponding to the respective (Dx)i; and, creating a series of construction material and labor lists for each BSi, the series of construction materials and labor lists composing a respective construction materials and labor list data structure. It should be appreciated that the series of construction materials and labor lists compose a respective construction materials and labor list data structure, MLi, where a substructure of data, (MLx)i, defines the construction material and labor list corresponding to the respective (Dx)i; wherein, CMi is a compilation of Si, FPi, BSi, and MLi; i is an integer ranging from 1 to I, where I consists of the number of development options; and, x is an integer ranging from 1 to X, where X consists of the number of development schemes corresponding to the respective Di.

The computer-implemented method further includes configuring the computational optimization engine with instructions for executing a transforming of the CMi into a respective optimization model, OMi, for the respective Di; wherein, OMi is configured include a series of functions having (i) a series of revenue-related parameters from CMi generating a total revenue, Ri, over a time, Ti; and, (ii) a series of cost-related parameters from CMi generating a total development cost, DCi, over a time, Ti; wherein Ti ranges from 0 to tin months; wherein, the series of functions include one or more constraint functions, (CFz)i, where z is an integer ranging from 1 to Z, Z including one or more zoning restrictions for Di; and, an objective function, OFi, Pi=Ri-DCi, where Pi is a profit margin. The transforming can include, for example, establishing a defined revenue domain by executing instructions in the revenue module that set a relationship between the total revenue, Ri, and the series of revenue-related parameters from the construction model, CMi, for the respective Di; establishing a defined cost domain by executing instructions in the cost module that set a relationship between a total development cost, DCi, and, a series of cost-related parameters from the construction model, CMi, for the respective Di; and, maximizing Pi by optimizing (i) the series of revenue-related parameters to identify Ropti, the optimized Ri for the respective Di; and, (ii) the series of construction-cost-related parameters to identify DCopti, the optimized DCi for the respective Di; wherein, the optimizing includes (i) assigning the OMi as a type of mathematical model, the assigning including determining whether the constraint functions, (CFz)i, are linear, non-linear, discrete, or a combination thereof; and, determining whether the objective function, OFi, is linear, non-linear, or discrete; (ii) matching an optimization technique to the type of mathematical model assigned; and, (iii) instructing the computational optimization engine to solve for Ropti and DCopti.

Knowing Ropti and DCopti, the computational optimization engine can be further configured with instructions for executing a calculating of a land valuation, LVi, for the respective Di; wherein, the calculating includes establishing a minimum return value, MRV, with the financial module; where, the MRV is a measure of return defined by a select, return calculation function, RCF, which is a function of Ropti, DCopti, LVi, and RCPy; where, RCPy is a set of one or more return calculation parameters for the respective RCF, where y is the number of parameters of return calculation parameters in RCP and is an integer ranging from 0 to Y; selecting the RCF, the selecting including setting the RCPy for use in the RCF; determining a maximum land value, LVmaxi, for the respective Di, the determining including maximizing LVi subject to RCF (Ropti, DCopti, LVi, RCPy) MRV; where, the LVmaxi is a maximum price to pay for the land to generate the MRV; and, repeating the determining of LVmaxi for each Di. The methods can also include providing a user interface operable to display the LVmaxi for each Di.

The RCF can be any known method of calculating return. The method chosen can be specific to the user, the development project, and/or the financing entity, for example. In some embodiments, the method can include an industry standard method of calculating return, such as a bank-preferred method. In these embodiments, the systems and methods provided herein intentionally incorporate select, industry standard financial calculations in the definition and use of a minimum return value. As such, the teachings provided herein gives financial institutions, for example, methods and systems to generate information needed to assess risk of investment. It should be appreciated that, in some embodiments, the RCF can include a cash-on-cash calculation and, as such, the RCPy can include a leverage ratio based on DCopti/equity. It should likewise be appreciated that, in some embodiments, the RCF comprises an internal rate of return calculation, and the RCPy can be a null set. As such, in some embodiments, the configuring of the computational optimization engine further includes configuring the computational optimization engine with instructions to calculate the RCF using a cash-on-cash calculation, and the RCPy includes a leverage ratio based on DCopti/equity. Likewise, the configuring of the computational optimization engine can further include configuring the computational optimization engine with instructions to calculate the RCF using an internal rate of return calculation, and the RCPy is a null set.

The systems and methods will include system components and processes for collecting and/or updating information for the database. As such, the systems and methods can further include components and systems for adding such data to the database, the adding including accessing a scraping module on a non-transitory computer readable medium, operably connected to the database, and configured with instructions for executing (i) a process of collecting data from an external data source, Sn, where n is an integer ranging from 1 to N, where N can represent the number of data sources in a set of data sources; and, (ii) a transporting of the data to the database to compile a compendium of data in the database.

One of skill will also appreciate that the data collected should be unified and systematized for use. As such, the methods can further comprising adding data to the database, the adding including accessing a scraping module on a non-transitory computer readable medium, operably connected to the database, and configured with instructions for executing (i) a process of collecting data from an external data source, Sn, where n is an integer ranging from 1 to N; (ii) a unification of n data protocols; (iii) a systemizing of the data from Sn; and, (iv) a transporting of the data to the database to compile a compendium of systematic data in the database.

The methods provided can incorporate market data, financial data, and cost data in their operation. As such, in some embodiments, the methods include adding market data for execution of instructions by the revenue module, for example. Likewise, in some embodiments, the methods can include adding financial data for execution of instructions by the financial module, for example. And, in some embodiments, the methods can include adding cost data for execution of instructions by the cost module, for example. It should also be appreciated that any combination of market data, financial data, and cost data can be used in some embodiments.

### BRIEF DESCRIPTION OF THE DRAWINGS

FIG. 1 is a general technology platform for a system or method taught herein, according to some embodiments.

FIGS. 2A and 2B are processor-memory diagrams to describe components of the system, according to some embodiments.

FIG. 3 is a concept diagram illustrating the system, according to some embodiments.

FIG. 4 illustrates the general method of determining a land value, according to some embodiments.

FIG. 5 illustrates a prior art method of using land sale “comparisons” to value land.

FIG. 6 illustrates a prior art method calculating land value as a “residual”.

FIG. 7 illustrates a generalized structure of the systems and methods provided herein, according to some embodiments.

FIG. 8 illustrates a general schematic of a computer system that can be used to perform methods provided herein, in some embodiments.

FIG. 9 illustrates a method of configuring the project module, according to some embodiments.

FIG. 10 illustrates the transformation of a development option into a construction model, according to some embodiments.

FIG. 11 illustrates the transformation of construction model data into an optimization model, according to some embodiments.

FIG. 12 illustrates a generalized flow of the transformation of construction model data into a total development cost using hard cost data and soft cost data, each which is optimized by the computational optimization engine to optimize revenue, optimize development cost, and maximize profit, according to some embodiments.

FIG. 13 illustrates a generalized flow of the transformation of the optimized revenue parameters and optimized development cost parameters of an optimized development project into a maximum price that could be paid for a “lot” of land for the project to remain economically feasible, according to some embodiments.

FIG. 14 illustrates a method of gathering and transforming data for use in making and using the systems, and performing the methods, provided herein, according to some embodiments.

FIG. 15 shows a manner in which the systems and methods are incorporated in a network environment, according to some embodiments.

FIGS. 16A and 16B provide an illustration of two building shapes that may be generated by the systems and methods provided herein in the optimization of revenue-related parameters and cost-related parameters, according to some embodiments.

FIGS. 17A and 17B illustrate a user interface that can be used to select a desired “lot” of land for analysis by placing a pin on a parcel, according to some embodiments.

FIGS. 18A and 18B illustrate a user interface that can be used to adjust the selection of a desired “lot” of land, according to some embodiments.

FIGS. 19A and 19B illustrate a drill-down into the analytics provided by the systems and methods provided herein, such as an overview and zoning analytics, for example, according to some embodiments

FIG. 20 illustrates a drill-down into the analytics provided by the systems and methods provided herein, such as design analytics, for example, according to some embodiments.

FIGS. 21A-21E illustrate a drill-down into the financial analytics provided by the systems and methods provided herein, such as hard costs, soft costs, financials, operating expenses, and sales process, for example, according to some embodiments.

FIG. 22 illustrates general data logic diagram, according to some embodiments.

### DETAILED DESCRIPTION

In the following detailed description, reference will be made to the accompanying drawing(s), in which identical functional elements are designated with like numerals. The aforementioned accompanying drawings show by way of illustration, and not by way of limitation, specific embodiments and implementations consistent with principles of the present invention. These implementations are described in sufficient detail to enable those skilled in the art to practice the invention and it is to be understood that other implementations may be utilized and that structural changes and/or substitutions of various elements may be made without departing from the scope and spirit of present invention. The following detailed description is, therefore, not to be construed in a limited sense. Additionally, the various embodiments of the invention as described may be implemented in the form of a software running on a general purpose computer, in the form of a specialized hardware, or combination of software and hardware.

State-of-the-art methods for determining the value of a lot of land for use in a development project are generally limited to an estimate that uses a simple comparables approach. With regard to feasibility analyses that would take into account such an estimate, current state of the art methods include (i) performing a “predesign phase” of typically a single, “select” development project and (ii) producing an estimated profit for the single, select project, each of which merely provides information that is subjective to the single, select development project. Since the process is costly and time-consuming, it is rare to look into more than one development option in this manner, although sometimes it will be done, perhaps, for a couple of, and maybe even a few, select development options. As stated above, one of skill in the art will appreciate having the computerized systems and computer-implemented methods provided herein that perform a complex series of data transformations to (i) identify a set of available development options for a select, lot of land using a database having zoning codes, zoning restrictions, building codes, and the like, for the select, lot of land; (ii) identify at least a substantial number of development schemes within each of the available development options (iii) maximize profit by identifying optimum cost-related parameters and optimum revenue-related parameters within the available development options; and, (iv) determine a land value by (a) establishing a minimum financial return needed for the development project to be economically feasible, (b) determining a maximum land value that should be paid for each development options based on the minimum financial return needed, and/or (c) assessing the relative maximum land values for each development option to determine the land value.

As stated above, the problem of selecting the best combination of land and project has no easy analytical (e.g. “manual”) solution. Therefore, one or more embodiments described herein utilize a specialized computational optimization algorithm deployed on a computer platform for selecting a “lot” of land for use in a development project, identifying a substantial number of development schemes for one or more of each of the development options for the lot, assembling a construction model for each of the development options, transforming the construction model into an optimization model that maximizes profit by computationally optimizing revenue and development cost for each development option, determining a maximum land value for each development option by establishing a minimum expected return, and determining a land value based on the set of maximum land values for the development options. The systems and methods provided herein computationally optimize the cost-related parameters and revenue-related parameters in order to maximize profit from the development project and determine the value for the lot based on a minimum expected return from the development project.

In some embodiments, the term “lot” can be used to refer to an area of land that could be used in an actual, or potential, development project. The lot can be designated by any coordinates, or set of coordinates, known to one of skill in identifying an area of land. The lot, for example, can be designated using one or more assessor's parcel numbers (APNs). In some embodiments, the lot might include only a portion of the land associated with a particular APN or set of APNs. The “parcel,” for example, can be used interchangeably with the term “lot”, in some embodiments. In some embodiments, the lot can be identified using longitude and latitude coordinates that set forth land boundaries, such as the corners of a land area.

One of skill will appreciate that a development project can be relatively small or relatively large in complexity and, as such, might require a relatively small lot or a relatively large lot. As such, the term “lot” can be used to refer to a land area of any size that may be needed in a development project. In some embodiments, the lot can include any one or any combination of land areas, for example, one or more parcels, the total of which can range from less than an acre to several acres. For example, a development might include an inner city lot ranging from 1000 square feet to 10,000 square feet, a suburban lot ranging from 4000 square feet to 20 acres, or a rural lot ranging from a half-acre to 1000 acres or more. As such, a “lot” can range, in some embodiments, from 1000 square feet to 1000 acres, from 4000 square feet to 1000 acres, from 8000 square feet to 1000 acres, from 10,000 square feet to 1000 acres, from 50,000 square feet to 1000 acres, from 100,000 square feet to 1000 acres, from 3000 square feet to 1 acre, from 6000 square feet to 2 acres, from 10,000 square feet to 10 acres, from 10,000 square feet to 5 acres, or any range therein in increments of 0.1 acres. In some embodiments, the lot can have an area of about 1000 square feet, about 2000 square feet, about 3000 square feet, about 5000 square feet, about 6000 square feet, about 7000 square feet, about 8000 square feet, about 10,000 square feet, about 15,000 square feet, about 20,000 square feet, about 30,000 square feet, about 50,000 square feet, about 100,000 square feet, or any area or range therein in increments of 500 square feet. In some embodiments, the lot can have an area of about 1 acre, about 2 acres, about 3 acres, about 5 acres, about 10 acres, about 20 acres, about 30 acres, about 40 acres, about 50 acres, about 100 acres, about 500 acres, about 1000 acres, or any area or range therein in increments of 1 acre.

The terms “operable,” “operably connected”, “functional”, and the like can be used herein to refer to any functional interconnection, such as a functional interconnection between system components. System components can include, but are not limited to, a module, set of modules, engine, set of engines, database, processor, user interface, or any combination thereof. In some embodiments, such a functional connection can include configuring a component to function through an instruction or set of instructions for executing a command or any other function through a processor. It should be appreciated that the command or other function can correspond to any component function, such as that of the module, set of modules, engine, set of engines, or any combination thereof.

As such, the teachings provided herein are generally directed, for example, to systems and methods for pursuing the highest net earnings from a development project by computationally optimizing the cost-related parameters and revenue-related parameters in order to maximize profit from the development project and determine a value for a lot of land. One of skill will appreciate that, for a process to calculate the highest net earning possible for the lot, the process should identify a maximum of a distribution of net earnings, and this can include identifying a distribution of development projects that are possible, as well as a distribution of development schemes within each of the development projects. It should be appreciated that the term “development scheme” can be used herein to represent one or more designs that are possible for a particular development option. In some embodiments, for example, the term “development scheme” may be used to define or describe just one of the vast number of construction variations, i.e. permutations, possible within a development option, each permutation of which represents a variation of at least a single construction parameter among the many parameters that exist within the development option. Likewise, in some embodiments, the term “development scheme” might be used to define a substructure of variations that are possible within a particular development option, each substructure sharing one or more common variations in construction parameters.

One of skill will appreciate that, to find the “maximum” of anything, one should first identify a distribution of data surrounding and defining the maximum value, and then locate the maximum within the distribution. In order to maximize the development potential of the lot, for example, a substantial number of development schemes for each of the development options can be identified to determine the highest net earnings with an acceptable degree of accuracy. In some embodiments, the maximum can represent the highest net earnings for a single development option, such that the maximum is provided by the development scheme within the single option that provides the highest net earnings. In some embodiments, the maximum can represent the highest net earnings for a subset of all development options, such that the maximum is provided by the development scheme within the subset of development options that provides the highest net earnings. In some embodiments, the maximum can represent the highest net earnings for all development options identified, such that the maximum is provided by the development scheme within the all of the development options identified that provides the highest net earnings. Moreover, to target the highest net earnings with fewer data points, the substantial number of development schemes can be, rather than merely random, based on an optimization of development costs and revenue to identify the best distribution of data from which to identify the development scheme having the highest net earnings. And, knowing the highest net earnings possible, it becomes possible to identify the maximum amount that should be paid for the lot in view of a minimum expected return on investment. The maximum amount to pay for the lot is a desired piece of information, as the feasibility of a project can depend on the cost of the lot used for the development project.

It should also be appreciated that the term “substantial” can be used to refer to a quantity that will provide a statistically significant measurement or change in the recited system, method, function, or other form of output that is derived from an input. A “substantial number”, for example, can be used to refer to any size population of data that provides a statistically significant measure of an output. In some embodiments, the substantial number be at least 30 data points, at least 100 data points, at least 500 data points, at least 1000 data points, at least 5000 data points, at least 10,000 data points, at least 100,000 data points, at least 500,000 data points, at least 1,000,000 data points, or any number of data points therein in increments of 10 data points. In some embodiments, the substantial number can range from 10 to 1,000,000 data points or more. In some embodiments, the substantial number can range from 30 to 1,000,000 data points or more. And, in some embodiments, the substantial number can be selected by the user to be any number or range of data points set forth above, or any set or subset of data obtained or obtainable using any method known to one of skill, and/or the teachings provided herein. In some embodiments, the output can be a maximum, a minimum, or other measure of an optimum value having a confidence interval of at least 60%, at least 65%, at least 70%, at least 75%, at least 80%, at least 85%, at least 90%, at least 95%, at least 96%, at least 97%, at least 98%, at least 99%, at least 99.5%, at least 99.7%, at least 99.9%, or any confidence interval therein in increments of 0.1%. In some embodiments, the confidence interval ranges from 60% to 99.9%. In some embodiments, the confidence interval ranges from 60% to 99.5%, from 60% to 99%, from 60% to 90%, from 60% to 85%, from 60% to 80%, from 60% to 75%, from 70% to 99.9%, from 70% to 99.5%, from 70% to 99%, from 70% to 95%, from 70% to 90%, from 70% to 85%, from 75% to 99.9%, from 75% to 99%, from 75% to 95%, from 75% to 90%, from 80% to 99.9%, from 80% to 99.5%, from 80% to 99%, from 80% to 95%, or any range therein, each end of the range varying in increments of 0.1%. In some embodiments, the output is maximum profit. In some embodiments, the output is minimum development cost. In some embodiments, the output is maximum revenue. In some embodiments, the output is minimum return. In some embodiments, the output is maximum land value.

Methods and systems are provided for determining a land value by computationally optimizing one or more development options, including one or more sets of development options. Generally speaking, systems and methods involve the steps of selecting (i) a lot of land to determine its value; (ii) identifying development options, Di, for the lot, and assembling a construction model, CMi, for each Di; (iii) transforming the construction model, CMi, into an optimization model, OMi, for each Di; and, (iv) determining a maximum land value, LVmaxi, for each Di to determine a land value for the lot.

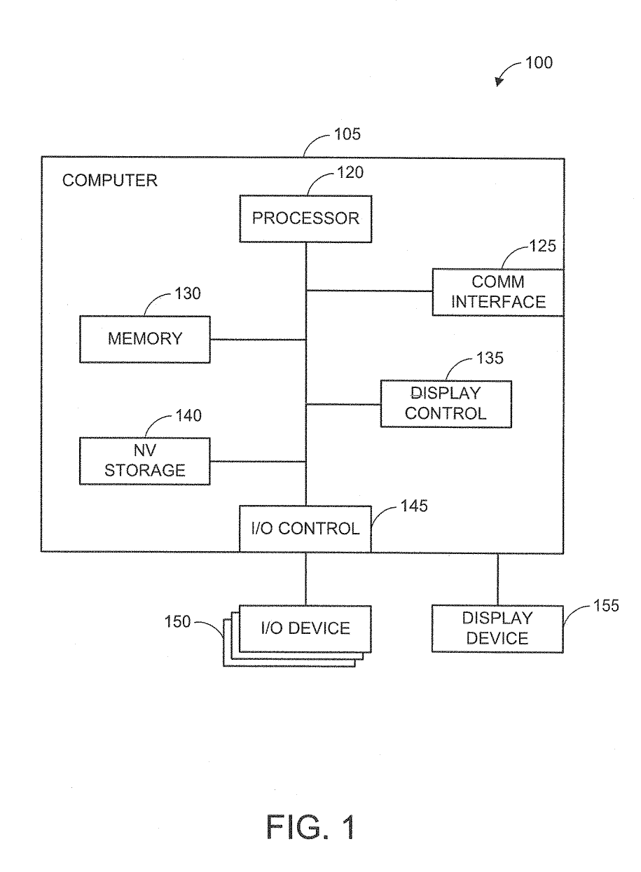

FIG. 1 is a general technology platform for a system or method taught herein, according to some embodiments. The computer system 100 may be a conventional computer system and includes a computer 105, I/O devices 150, and a display device 155. The computer 105 can include a processor 120, a communications interface 125, memory 130, display controller 135, non-volatile storage 140, and I/O controller 145. The computer system 100 may be coupled to or include the I/O devices 150 and display device 155.

The computer 105 interfaces to external systems through the communications interface 125, which may include a modem or network interface. It will be appreciated that the communications interface 125 can be considered to be part of the computer system 100 or a part of the computer 105. The communications interface 125 can be an analog modem, isdn modem, cable modem, or other interfaces for coupling the computer system 100 to other computer systems. In a cellular telephone, including smart phones, or other device receiving information in the same or similar manner, this interface is typically a radio interface for communication with a cellular network and may also include some form of cabled interface for use with an immediately available personal computer. In a personal digital assistant, the communications interface 125 typically includes a cradled or cabled interface and may also include some form of radio interface, such as a BLUETOOTH or 802.11 interface, ora cellular radio interface, for example.

The processor 120 may be, for example, any suitable processor, such as a conventional microprocessor including, but not limited to, an Intel Pentium microprocessor or Power PC microprocessor, a Texas Instruments digital signal processor, or a combination of such components. The memory 130 is coupled to the processor 120 by a bus. The memory 130 can be dynamic random access memory (DRAM) and can also include static ram (SRAM). The bus couples the processor 120 to the memory 130, also to the non-volatile storage 140, to the display controller 135, and to the I/O controller 145. In some embodiments, for example, the processors can include an ARM architecture such as the architecture present in, for example, CORTEX-A Series, CORTEX-R Series, CORTEX-M Series, SECURCORE Series processors (available, for example, from ARM, Inc., 150 Rose Orchard Way, San Jose, Calif. 95134-1358).

The I/O devices 150 can include a keyboard, disk drives, printers, a scanner, and other input and output devices, including a mouse or other pointing device. And, the teachings provided here include a navigation device having an indexing state selector and a scrolling state selector. The display controller 135 may control in the conventional manner a display on the display device 155, which can be, for example, a liquid crystal display (LCD), or perhaps a light-emitting-diode display (LED), in addition to touchscreen technologies. The display controller 135 and the I/O controller 145 can be implemented with conventional well known technology, meaning that they may be integrated together, for example.

The non-volatile storage 140 is often a FLASH memory or read-only memory, or some combination of the two. A magnetic hard disk, an optical disk, or another form of storage for large amounts of data may also be used in some embodiments, although the form factors for such devices typically preclude installation as a permanent component in some devices. Rather, a mass storage device on another computer is typically used in conjunction with the more limited storage of some devices. Some of this data is often written, by a direct memory access process, into memory 130 during execution of software in the computer 105. One of skill in the art will immediately recognize that the terms “machine-readable medium” or “computer-readable medium” includes any type of storage device that is accessible by the processor 120 and also encompasses a carrier wave that encodes data information. Objects, methods, inline caches, cache states and other object-oriented components may be stored in the non-volatile storage 140, or written into memory 130 during execution of, for example, an object-oriented software program.

The computer system 100 is one example of many possible different architectures. For example, personal computers based on an Intel microprocessor often have multiple buses, one of which can be an I/O bus for the peripherals and one that directly connects the processor 120 and the memory 130 (often referred to as a memory bus). The buses are connected together through bridge components that perform any necessary translation due to differing bus protocols.

In addition, the computer system 100 can be controlled by operating system software which includes a file management system, such as a disk operating system, which is part of the operating system software. One example of an operating system software with its associated file management system software is the family of operating systems known as WINDOWS, such as WINDOWS 7, WINDOWS 8, and their associated file management systems (available, for example, from Microsoft Corporation of Redmond, Wash.). Another example of an operating system software with its associated file management system software is the MAC OS software, such as MAC OS X. Another example of operating system software with its associated file management system software is the LINUX operating system and its associated file management system. Another example of an operating system software with its associated file management system software is the PALM operating system and its associated file management system. Another example of an operating system is an ANDROID, or perhaps an iOS, operating system. The file management system is typically stored in the non-volatile storage 140 and causes the processor 120 to execute the various acts required by the operating system to input and output data and to store data in memory, including storing files on the non-volatile storage 140. Other operating systems may be provided by makers of devices, and those operating systems typically will have device-specific features which are not part of similar operating systems on similar devices. Similarly, IOS or ANDROID operating systems, for example, may be adapted to specific devices for specific device capabilities.

The computer system 100 may be integrated onto a single chip or set of chips in some embodiments, and can be fitted into a small form factor for use as a personal device. Thus, it is not uncommon for a processor, bus, onboard memory, and display/I-O controllers to all be integrated onto a single chip. Alternatively, functions may be split into several chips with point-to-point interconnection, causing the bus to be logically apparent but not physically obvious from inspection of either the actual device or related schematics.

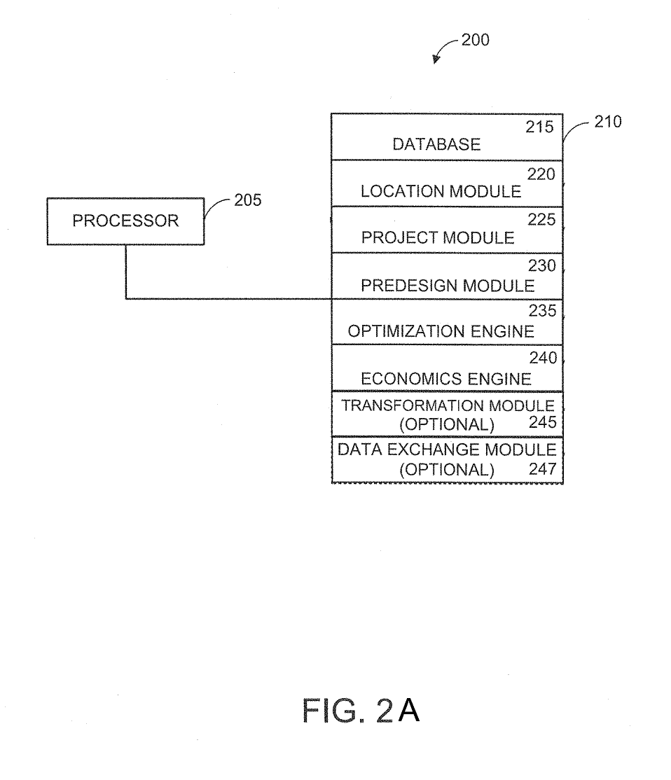

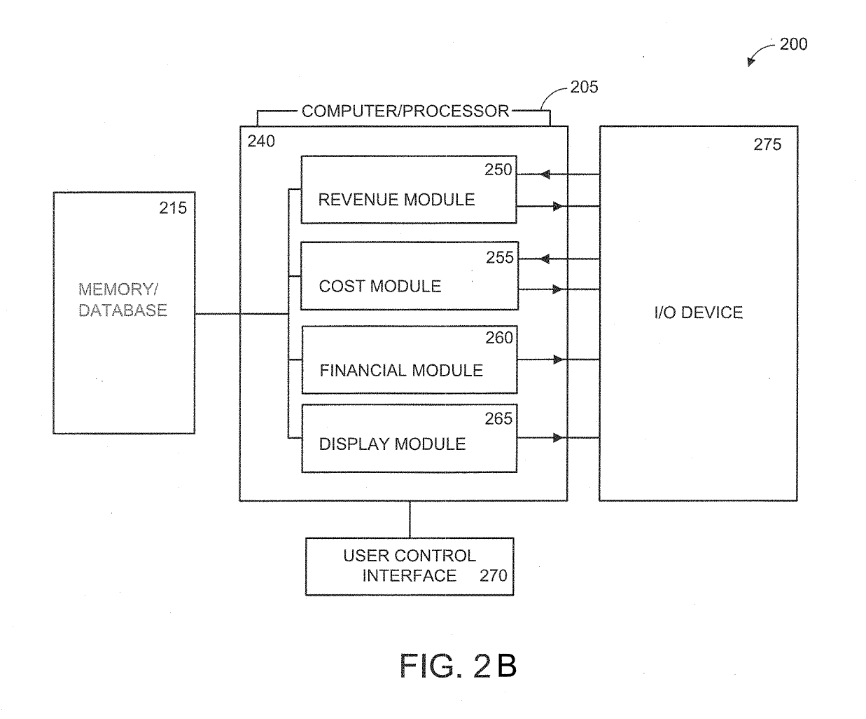

FIGS. 2A and 2B illustrate processor-memory diagrams to describe components of the system, according to some embodiments. In FIG. 2A, the system 200 shown in FIG. 2 contains a processor 205 and a memory 210 (that can include non-volatile memory), wherein the memory 210 includes a database 215, a location module 220, a project module 225, a predesign module 230, a computational optimization engine 235, an economics engine 240, an optional transformation module 245, and an optional data exchange module 250. The optional data exchange module 245 embodied in a non-transitory computer readable medium is operable to exchange data with external computer readable media. The database 215 can be operably connected to the processor 205 and on a non-transitory computer readable storage medium for storing data that is viewed by a user in any format; the location module 220 operably connected to the processor 205 and on a non-transitory computer readable storage medium for the execution of instructions on the processor for selecting a lot of land; the project module 225 operably connected to the processor 205 and on a non-transitory computer readable storage medium for identifying land development options, Di; the predesign module 230 operably connected to the processor 205 and on a non-transitory computer readable storage medium for assembling a construction model, CMi for each Di.

The system includes an input device (not shown) operable to receive data on a non-transitory computer readable medium. Examples of input devices include a data exchange module 247 operable to interact with external data formats, voice-recognition software, a hand-held device in communication with the system including, but not limited to, a microphone, and the like, as well as a camera or other video image capture and transmission device. It should be appreciated that the system can be adapted to receive an analog or digital audio or video.

The database 215 can be operable to store any type of data files for access on a non-transitory computer readable storage medium. In some embodiments, the system can store any data, including numerical, text, audio, and video data, and the like. Any file known to one of skill in the art can be stored, including, but not limited to files composed of digital data that can be rasterized for use on a computer display or printer. An image file format may be used to store data such as, for example, in uncompressed, compressed, or vector formats. In some embodiments, the system can receive, store, and provide access to any of a variety of formats through a data exchange module, as discussed above.

In addition, the system can include a computational optimization engine 235 embodied in a non-transitory computer readable medium, wherein the computational optimization engine 235 is operable to transform the construction model, CMi, into a respective optimization model, OMi. As shown in FIG. 2B, the system can also include an economics engine 240, which can drive or comprise modules having instructions for executing economics data on the processor. In some embodiments, the economics data can include, for example, market data executed by revenue module 250, development cost data executed by a cost module 255, or financial data executed by a financial module 260.

One of skill will appreciate that “market data” can include any size data set, from a null set to a vast amount of data. For example, the market data can include a wide variety of data that can affect the market for a development project, as well as the prices and revenue related to the development project. In some embodiments, market data can include, for example, recent sales, recent sales days on the market, current inventory, current inventory days on market, inventory trend, inventory market sector trends, traffic, and demographics. In some embodiments, the market parameters can include financial market parameters. Examples of financial market parameters can include, but are not limited to, risk free rate, risk premium, historic risk free rate, historic risk premium, risk free rate trend, risk premium trend, cost of capital, and the like. The system and methods provided here can provide for adjustments through the entry of user-defined variables, such as FICO score, income, and the like.

In some embodiments, the user interface can be any I/O device, such as an input device that comprises a microphone and/or camera. In some embodiments, the I/O device is an output device comprising a speaker, a graphical user interface, or both a speaker and a graphical user interface, for example. One of skill will appreciate that the teachings provided herein are not limited to particular file formats, and that any data, text, audio or video format known to one of skill in the art can be used in some embodiments.

The systems and methods provided herein can provide visual data feedback. For example, the systems and methods can include displaying satellite images of the systems, such as the location of a piece of land. In addition to controlling the systems, images of the systems can be obtained and modified for viewing. As such, the systems can include the ability to modify images, enhance images, combine images, average images, subtract one image from another, change image format, and the like. The systems can further comprise the transformation module 245 operably connected to the processor 205 and on a non-transitory computer readable storage medium for transforming image data into a modified set of images by the user. Likewise, the user can have the ability to select images from within a set of images accumulated over time using, for example, image addition, subtraction, filtering, or other software image algorithms or other known methodologies, default image criteria, and the like. The transformation module can include image analysis functionality to extract qualitative and/or quantitative information from images using digital image processing techniques that can include, for example, pattern recognition, digital geometry, and other forms of processing analog and digitized data, for example temporal or spatial processing, known to those of skill.

One of skill will also appreciate the value in communicating information with a second user, information including any data, text, audio, visual, or otherwise. For example, the second user can be a part of a service provider network, or a local emergency services network, that can assist in the analysis or interpretation of data from the systems taught herein. As such, the system can further comprise a data exchange module 247 for sending or receiving data with a second user, for example, in an instant messaging, chatting, bulletin board, or other such communication capacity. The data exchange module 247 can be embodied in a non-transitory computer readable medium and operable in that it has instructions for executing such data exchange on a processor, to exchange data with external computer readable media. The data exchange module can also, for example, be configured to serve as a messaging module operable to allow users to communicate with other users having like subject-profiles, or others users in a profile independent manner, merely upon election of the user. For example, users with the same or similar systems may be able to discuss system operation, performance, maintenance, and the like, within a computer network. The users can email one another, post blogs, or have instant messaging capability for real-time communications. In some embodiments, the users have video and audio capability in the communications, wherein the system implements data streaming methods known to those of skill in the art. In some embodiments, the system is contained in a hand-held device; operable to function as a particular machine or apparatus having the additional function of telecommunications, word processing, or gaming; or operable to function as a particular machine or apparatus not having other substantial functions.

The systems taught herein can be practiced with a variety of system configurations, including personal computers, multiprocessor systems, microprocessor-based or programmable consumer electronics, network PCs, minicomputers, mainframe computers, and the like. The teachings provided herein can also be practiced in distributed computing environments where tasks are performed by remote processing devices that are linked through a communications network. As such, in some embodiments, the system further comprises an external computer connection through the data exchange module 247 and a browser program module (not shown). The browser program module (not shown) can be operable to access external data as a part of the data exchange module 247.

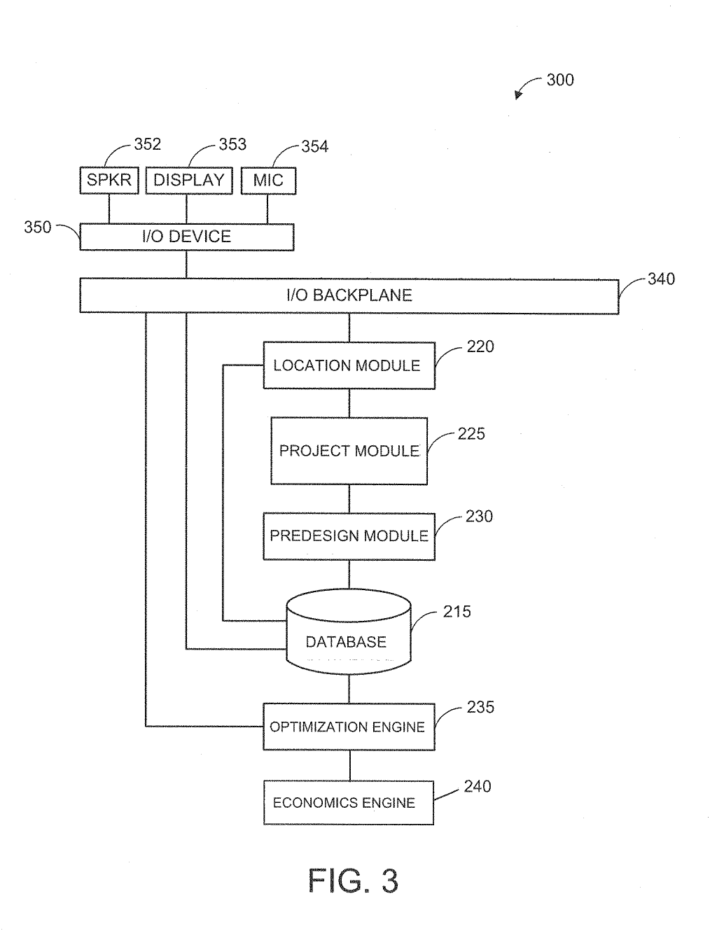

FIG. 3 is a concept diagram illustrating the system, according to some embodiments. The system 300 contains components that can be used in a typical embodiment. In addition to the database 215, the location module 220, the project module 225, the predesign module 230, the computational optimization engine 235, and the economics engine 240 shown in FIG. 2, FIG. 3, for example, illustrates the I/O device 350 which connects to a speaker (spkr) 352, display 353, and microphone (mic) 354, but which could also be coupled to other features, with each operably connected to the I/O backplane 340.

In some embodiments, the system is a web enabled application and can use, for example, Hypertext Transfer Protocol (HTTP) and Hypertext Transfer Protocol over Secure Socket Layer (HTTPS). These protocols provide a rich experience for the end user by utilizing web 2.0 technologies, such as AJAX, Macromedia Flash, etc. In some embodiments, the system is compatible with Internet Browsers, such as CHROME, INTERNET EXPLORER, Mozilla FIREFOX, OPERA, SAFARI, etc. In some embodiments, the system is compatible with mobile devices, such as smart phones, having full HTTP/HTTPS support, such as IPHONE, Microsoft SURFACE, and the like. This protocol will serve the non HTTP enabled mobile devices, such as cell phones, smart phones, BlackBerries, Droids, etc., and provides a simple interface. Due to protocol limitations, the Flash animations are disabled and replaced with Text/Graphic menus. In some embodiments, the system can be accessed using a Simple Object Access Protocol (SOAP) and Extensible Markup Language (XML). By exposing the data via SOAP and XML, the system provides flexibility for third party and customized applications to query and interact with the system's core databases. For example, custom applications could be developed to run natively on IPHONES, IPADS, ANDROID systems such as smart phones, tablets, and the like, including Java or .Net-enabled platforms, etc. One of skill will appreciate that the system is not limited to any of the platforms discussed above and will be amenable to new platforms as they develop.

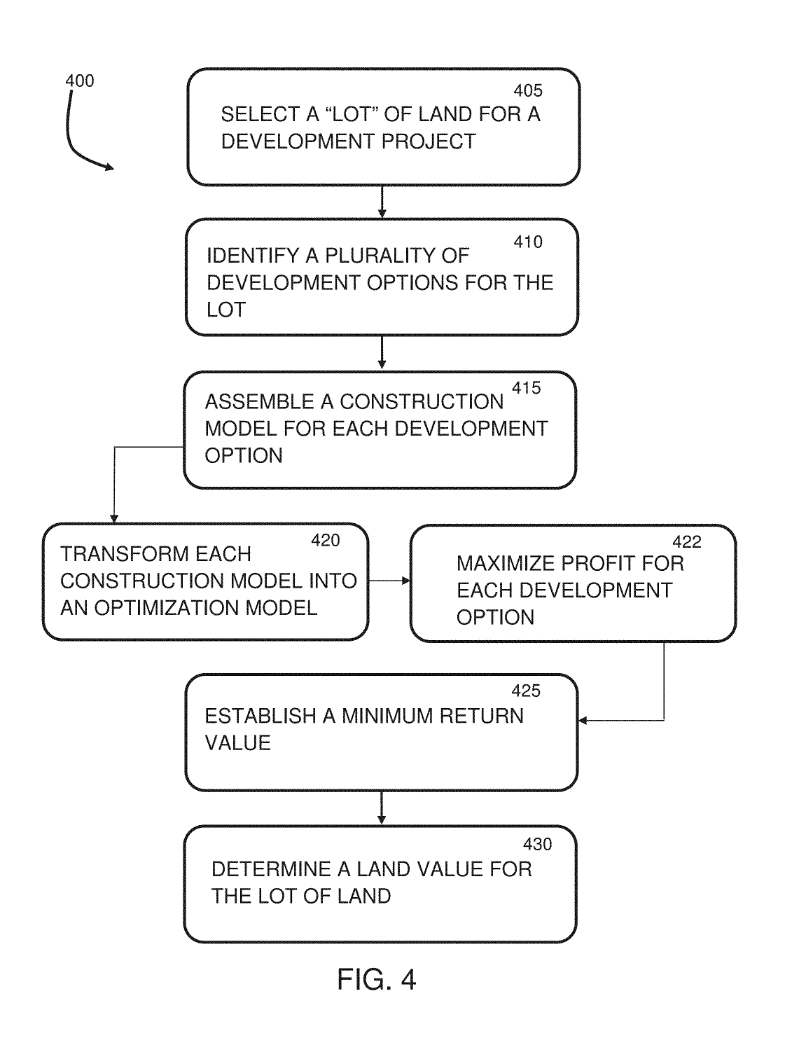

FIG. 4 illustrates the general method of determining a land value, according to some embodiments. In the general method 400, the first step is to select 405 a “lot” of land for a development project, for example, a parcel identified by an assessor's parcel number (APN), an area of land designated by coordinates, or some other identifier used to define the lot of interest. After the lot is selected, a complex series of data transformations can be performed to identify 410 a plurality of development options, one or more of which, preferably each of which, can include a set of at least a substantial number of available development schemes for the select, lot of land. The development options can be discovered using information from a database having zoning codes, zoning restrictions, building codes, and the like, for the select, lot of land. After the lot is selected and the development options are identified, the next step is to assemble 415 a construction model that represents variations of each development option. The next step is to transform 420 each construction model into a respective optimization model and to maximize 422 profit from the respective development option by optimizing revenue and development cost. The next step is to establish 425 a minimum return value with a return calculation function to determine a maximum land value that should be paid for each respective development option. And, finally, the maximum land values that are determined for each respective development option can be used to assess or determine 430 a land value for the lot.

It should be appreciated that, in some embodiments, the same minimum return value and return calculation function can be used to directly compare all development options. However, in some embodiments, more than one minimum return value and/or return calculation function may be desired and used with the teachings set-forth herein. This variation, for example, allows for a direct comparison between subsets of all development options. This may be done, for example, where the basis of return, or minimum return value needed, might be different, or calculated differently, between subsets of development options.

One of skill will appreciate that “zoning code”, “zoning rules”, “zoning regulations”, “zoning restrictions”, “zoning”, and like terms, can be used to refer to a land-use planning system used by local governments. The general concept is to divide land into mapped zones which separate one set of land uses from another, often to separate incompatible uses, to avoid overlapping commercial use with residential use, etc. For example, a zoning code may regulate density, building height, lot coverage, set-backs, and other such building and use characteristics. As such, zoning also regulates uses on a particular lot of land, such as residential, agricultural, commercial, or industrial. One of skill will appreciate that the term “density” can be used as a measurement of “land-use intensity,” for example, through a variety of units of measure. The units of measure of density can include, but are not limited to, floor-to-area ratio (FAR) as a measure of total square footage of the building structures to the total square footage of the lot upon which the building structures are developed; number of dwelling units per lot ranging, for example, from a single family dwelling to a huge, multi-story building; and, perhaps, the number of detached housing units per acre; to name a few.

One of skill will also appreciate that development costs can be divided into subsets of costs, for example, hard costs and soft costs. In some embodiments, the term “hard cost” can be used in reference to expenses that can be directly tied to the physical construction of the building structure. Likewise, in some embodiments, the term “soft cost” can be used for expenses that are not directly tied to the physical construction of the building structure. Examples of hard costs can include, but are not limited to, the labor and materials directly tied to the construction of the physical building structure, or any combination of labor and/or materials. Examples of soft costs can include, but are not limited to, marketing and advertising, design fees, professional fees, financing-related costs, lease administration, property taxes, administrative costs, lease expenses, permit fees, and insurance premiums, or any combination thereof.

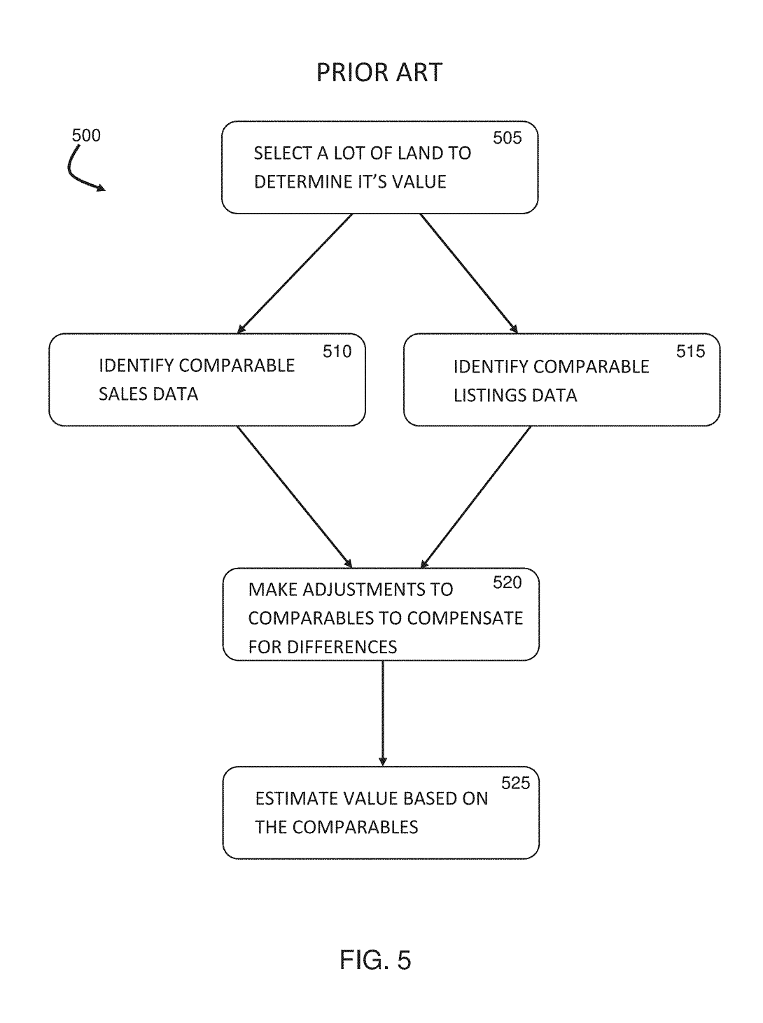

FIG. 5 illustrates a prior art method of using land sale “comparisons” to value land. In FIG. 5, a possible land sales comparison approach, the standard valuation method for raw land, is shown as a series of steps that one of skill will appreciate can occur in alternative sequences. The first step in the prior art method 500 is to select 505 a lot of land to determine its value, and then identify 510,515 comparable property values using either actual sales data or listings data. A problem is that land sales typically have few sales closed in a given market, making actual comparable sales hard to find, and adjustments required. As such, a step in the process can include making 520 adjustments to any comparables to compensate for differences between the properties. Adjustments can include many factors, for example, parcel size and shape, zoning, and utility availability, as well as the time that has passed since the comparable sale. As such, this method carries a large probability of making an error in the estimates.

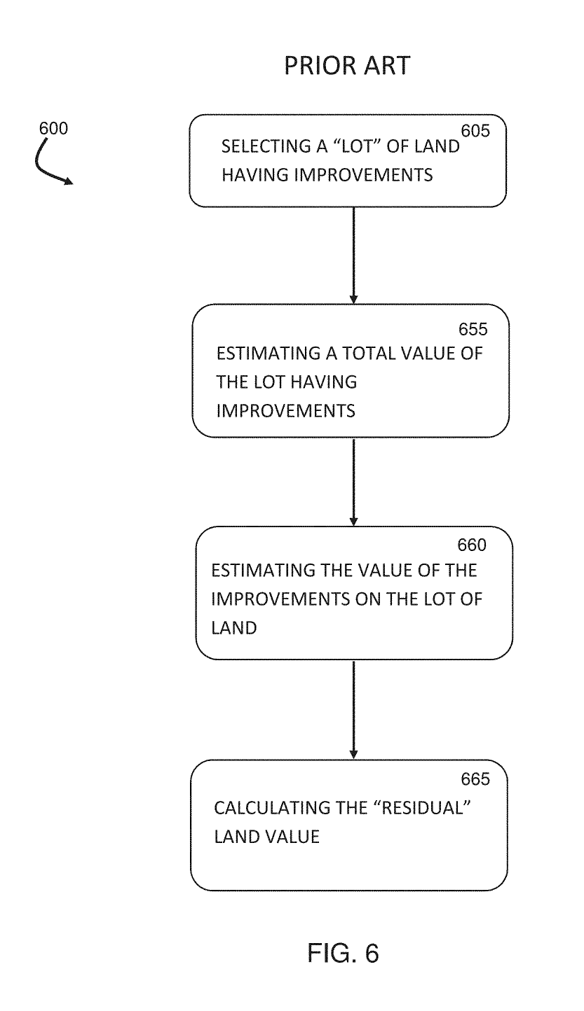

FIG. 6 illustrates a prior art method calculating land value as a “residual”. This method estimates the total value of the land with any improvements using a comparable sales approach, estimates the value of the improvements using a cost-approach, and subtracts the estimated value of the improvements from the total value to determine the residual value of the land. Again, since the total value is based on “comparables,” this method also suffers the problem of introducing error through the use of comparables twice: first in the use of comparables to estimate the total value, and second by estimating what it would cost to build a similar improvement. The first step in this prior art method 600 is to select 605 a lot of land having improvements; estimating 655 a total value of the lot having improvements using sale prices of similar improved lots; estimating 660 the value of the improvements using comparable development costs, while leaving the land value as an unknown “residual” amount. Error is introduced twice using the comparables approach and again through adjustments. And, finally, calculating 665 the “residual” land value.

FIG. 7 illustrates a generalized structure of the systems and methods provided herein, according to some embodiments. The structure 700 is divided into the steps of gathering 717 data, storing 737 data, and modeling 757 data. As shown in FIG. 7, the gathering 717 is a process that includes the use of an external data schema to structure data gathered, doing a scrape for data that is then systemized, the scrape using a scraper engine to gather data from external data sources. The storing 737 of data is a process that can be configured according to the external data schema that can be configured to store any preferred data structure that includes genus, sub-genus, or category of data relevant to selecting, designing, optimizing, and determining the feasibility of, a variety of development projects. The external data schema can include, for example, structures of parcel data, zoning data, standards data, market data, financial data, and cost data. The modeling 757 is a process of selecting a “lot” of land for a development project. After the lot is selected, a complex series of data transformations can be performed to identify a plurality of development options using information stored in the database in the form of zoning codes, zoning restrictions, and building codes for the select, lot of land. The parameters defining the development options are identified and a construction model is built to model variations of each development option. The next step is to transform each construction model into a respective optimization model which is used to maximize profit from the respective development option by optimizing revenue and development cost. The next step is to do a land value calculation by establishing a minimum return value with a return calculation function to make land valuations that are each a maximum land value that should be paid for each respective development option, the maximum land value calculated using the minimum return value, optimized revenue, and development cost of each development option. Finally, the maximum land values corresponding to each development option are assessed and viewed by the user with an evaluation explanation at the user interface.

One of skill will appreciate that there are numerous methods in which a “return” can be calculated in an economic feasibility study. Examples of such methods include, but are not limited to, internal rate of return (IRR), cash-on-cash (which can be annualized, for example), compound net annual rate (CNAR), pre-tax rate of return, post-tax rate of return, nominal rate of return, abnormal return, actual return, expected return, real rate of return, required rate of return (RRR), dividend-adjusted return, inflation-adjusted return, return on invested capital, modified internal rate of return (MIRR), unlevered development internal rate of return (UDIRR), levered development internal rate of return (LDIRR), equity partners' return (MPIRR & DPIRR), capitalization rate (cap rate), and gross rent multiplier (GRM), to name only a few. Such methods are well-known in the art and can be readily integrated with the systems and methods provided herein.

The systems and methods include configurations for pursuing the highest net earnings from a development project by computationally optimizing the cost-related parameters and revenue-related parameters in order to maximize profit from the development project and determine a value for a lot of land. The methods and systems can also be configured to determine a land value by computationally optimizing a series of development options. Generally speaking, in some embodiments, systems and methods can involve the steps of selecting (i) a lot of land to determine its value; (ii) identifying development options, Di, for the lot, and assembling a construction model, CMi, for each Di; (iii) transforming the construction model, CMi, into an optimization model, OMi, for each Di; and, (iv) determining a maximum land value, LVmaxi, for each Di to determine a land value for the lot.

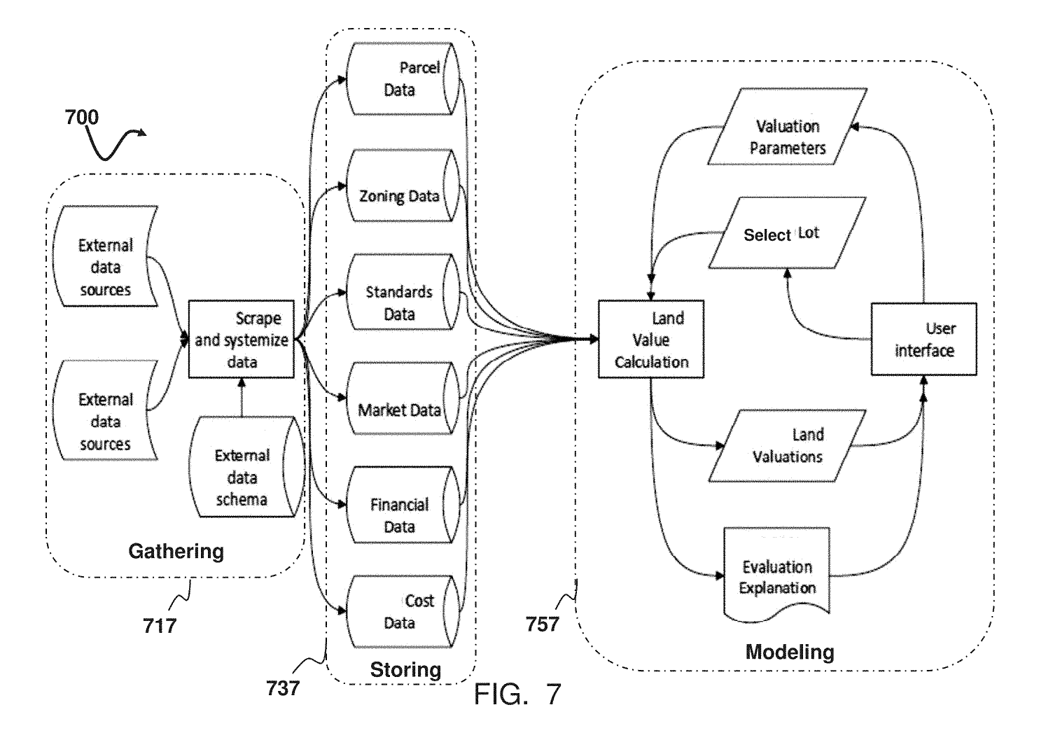

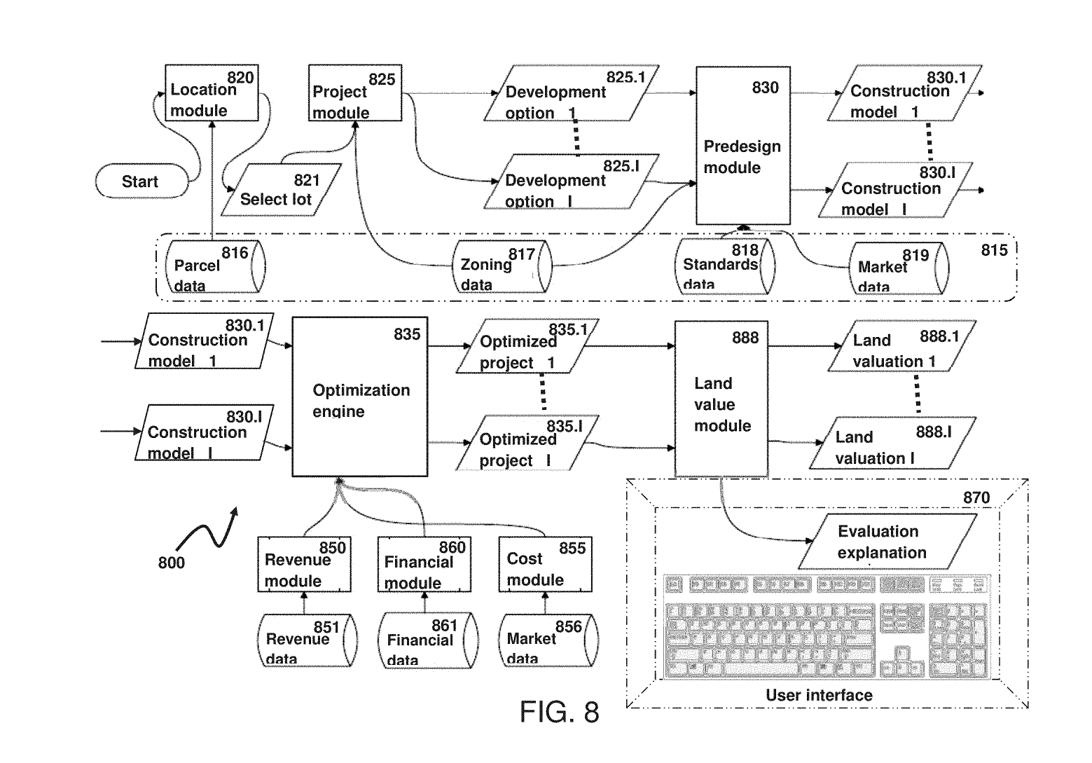

FIG. 8 illustrates a general schematic of a computer system that can be used to perform methods provided herein, in some embodiments. The methods can comprise accessing a computer system 800 having a user interface 870, a processor 805 (not shown), a memory 810 (not shown) that includes a database 815, a location module 820, a project module 825, a predesign module 830, a computational optimization engine 835, a revenue module 850, a cost module 855, and a financial module 860, each of which is on a non-transitory computer readable storage medium and operably connected to a processor 805 (not shown). The method includes selecting a lot of land with the location module 820, and identifying a plurality of development options for the lot with the project module 825. The identifying can include extracting zoning data from the database 815 for the lot, the zoning data including zoning restrictions, and identifying each development option data structure, Di, in the plurality of development options. One of skill will appreciate that the embodiments taught herein include distributed systems comprising a plurality of user interfaces, processors, databases, etc.

One of skill will appreciate from the teachings provided herein that the predesign module is configured to assemble a construction model for each development option. The construction model is assembled from a wide variety of data gathered for each development option which can include, for example, zoning data, restriction data, and building shape data, floor plan data, building structure data, construction material and labor data lists, for example. As such, predesign generation can include building shape creation, floor plan creation, floor construction, building materials, labor requirements, foundation and roof requirements, land plan (position of the building), or a combination thereof.

As such, the methods further include assembling a construction model, CMi, for each Di with the predesign module 830, wherein the assembling includes architecting a development scheme substructure of data, (Dx)i, for each Di. The architecting can include, for example, creating a list of restriction parameters obtained from the database 815 for each Di, each restriction parameter in the list used in defining a respective (Dx)i; creating a series of shapes for each Di, the series of shapes composing a respective shape data structure, Si, where a substructure of data, (Sx)i, defines the shape corresponding to the respective (Dx)i; creating a series of floor plans for each Si, the series of floor plans composing a respective floor plan data structure, FPi, where a substructure of data, (FPx)i, defines the floor plan corresponding to the respective (Dx)i; creating a series of building structures for each Di, the series of building structures composing a respective building structure data structure, BSi, where a substructure of data, (BSx)i, defines the building structure corresponding to the respective (Dx)i; and, creating a series of construction material and labor lists for each BSi, the series of construction materials and labor lists composing a respective construction materials and labor list data structure, MLi, where a substructure of data, (MLx)i, defines the construction material and labor list corresponding to the respective (Dx)i; wherein, CMi is a compilation of Si, FPi, BSi, and MLi; i is an integer ranging from 1 to I, where I consists of the number of development options; and, x is an integer ranging from 1 to X, where X consists of the number of development schemes corresponding to the respective Di.

The methods can further include transforming CMi into a respective optimization model, OMi, for the respective Di with the computational optimization engine 835; wherein, OMi includes a series of functions having (i) a series of revenue-related parameters from CMi generating a total revenue, Ri, over a time, Ti; and, (ii) a series of cost-related parameters from CMi generating a total development cost, DCi, over a time, Ti; wherein Ti ranges from 0 to t, which can be in any increment of time, such as months in some embodiments. It should be appreciated, for example, that t can be any increment of time which can include, for example, an increment of days, weeks, months, etc. In some embodiments, the increment of time can be used in any manner desired or required to perform a financial calculation, and this may include the use of a combination of time increments, such as a combination of days, weeks, and/or months, a combination thereof, or a fraction of one or any combination of units thereof. The series of functions can include, for example, one or more constraint functions, (CFz)i, where z is an integer ranging from 1 to Z, Z including one or more zoning restrictions for Di; and, an objective function, OFi, Pi=Ri-DCi, where Pi is a profit margin. The transforming can include, for example, establishing a defined revenue domain by executing instructions in the revenue module 850 for processing revenue data 851 on the processor 805 (not shown), the instructions setting a relationship between the total revenue, Ri, and the series of revenue-related parameters from the construction model, CMi, for the respective Di; establishing a defined cost domain by executing instructions in the cost module 855 for processing cost data 856 on the processor 805 (not shown), the instructions setting a relationship between a total development cost, DCi, and, a series of cost-related parameters from the construction model, CMi, for the respective Di; and, maximizing Pi by optimizing (i) the series of revenue-related parameters to identify Ropti, the optimized Ri for the respective Di; and, (ii) the series of construction-cost-related parameters to identify DCopti, the optimized DCi for the respective Di; wherein, the optimizing includes (i) assigning the OMi as a type of mathematical model, the assigning including determining whether the constraint functions, (CFz)i, are linear, non-linear, discrete, or a combination thereof; and, determining whether the objective function, OFi, is linear, non-linear, or discrete; (ii) matching an optimization technique to the type of mathematical model assigned; and, (iii) instructing the computational optimization engine to solve for Ropti and DCopti and create optimized project 1 835.1 to optimized project I 835.1.

One of skill will appreciate that the term “total” can refer to any total amount that is used for purposes of any calculation set-forth herein. For example, the term “total” can be used as a true, or actual, total amount; or, in some embodiments, it can be less than the true or actual total amount, excluding amounts for purposes of making or simplifying a calculation taught herein. As such, a “total revenue over time” can refer to a select portion of a true total revenue from the project. Likewise, a “total development cost over time” can refer to a portion of a true total development cost from the project. However, one of skill will appreciate that the total revenue and total development costs should share a basis of calculation. Embodiments taught herein, for example, can share the construction model as a basis of calculation.

The methods can further include calculating the land valuation, LVi, which can also be done with the computational optimization engine 835 for the respective Di. In the alternative, a land value module 888 can be used. The calculating can include establishing a minimum return value, MRV, by executing instructions in the financial module 860 for processing financial data 861 on the processor 805 (not shown); where, the MRV is a measure of return defined by a select, return calculation function, RCF, which can be a function of Ropti, DCopti, LVi, and RCPy; where, RCPy is a set of one or more return calculation parameters for the respective RCF, where y is the number of return calculation parameters in RCP and is an integer ranging from 0 to Y. As such, the calculating can include selecting the RCF, the selecting including setting the RCPy for use in the RCF; determining a maximum land value, LVmaxi, for the respective Di, the determining including maximizing LVi subject to RCF (Ropti, DCopti, LVi, RCPy)≧MRV; where, the LVmaxi is a maximum price to pay for the land, for example for project 1 888.1 to project I 888.I, to generate the MRV; and, repeating the determining of LVmaxi for each Di. And, the methods can also include assessing the relative values of LVmaxi for each Di and determining a land value for development of the parcel of land. The method can also provide an explanation of the evaluation of land values on the user interface 870 by executing instructions in the land value module on the processor for the evaluation.

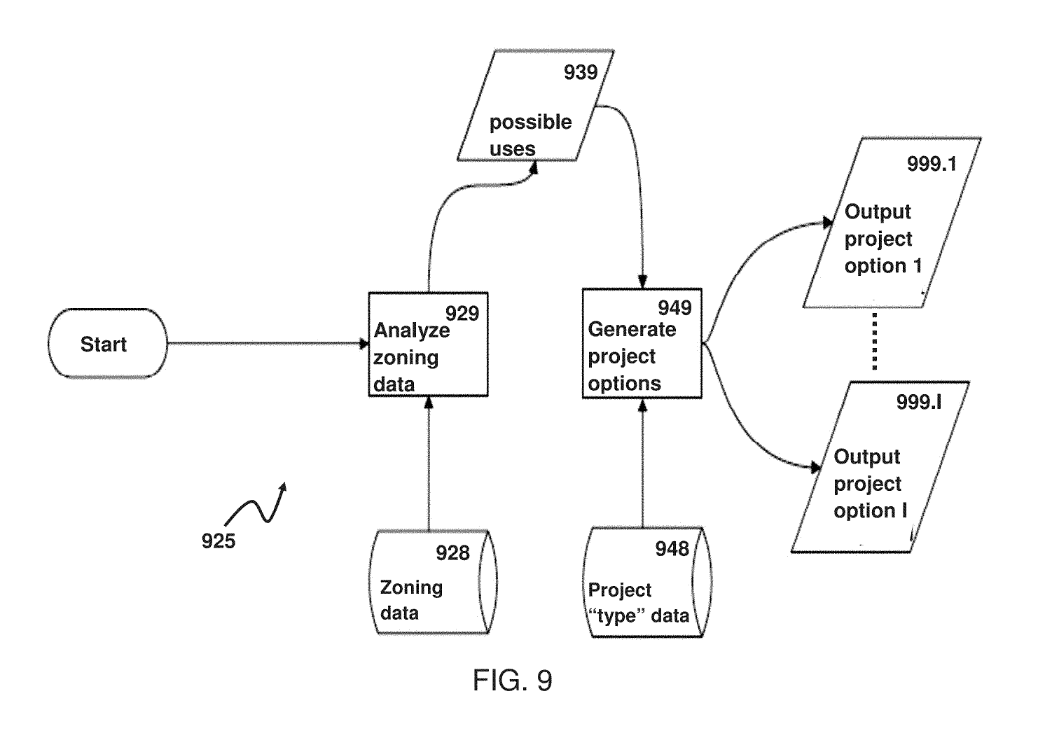

FIG. 9 illustrates a method of configuring the project module, according to some embodiments. The project module 925 can be configured with a variety of instructions for execution on a processor 915 (not shown). The project module 925 can include instructions to analyze 929 zoning data 928 for a select lot, along with instructions to identify the possible uses 939 for the lot from the zoning data 928. The project module 925 can also be configured with instructions to generate 949 project options, also referred to herein as development options, the options generated by matching the zoning data 928 with available project “type” data 948. Finally, the project module 925 is configured with instructions to create a range of outputs from output project option 1 999.1 (“development option 1”) to project option I 999.I (“development option I”) for use in building construction model 1 to construction model I, as referred to in FIG. 8.

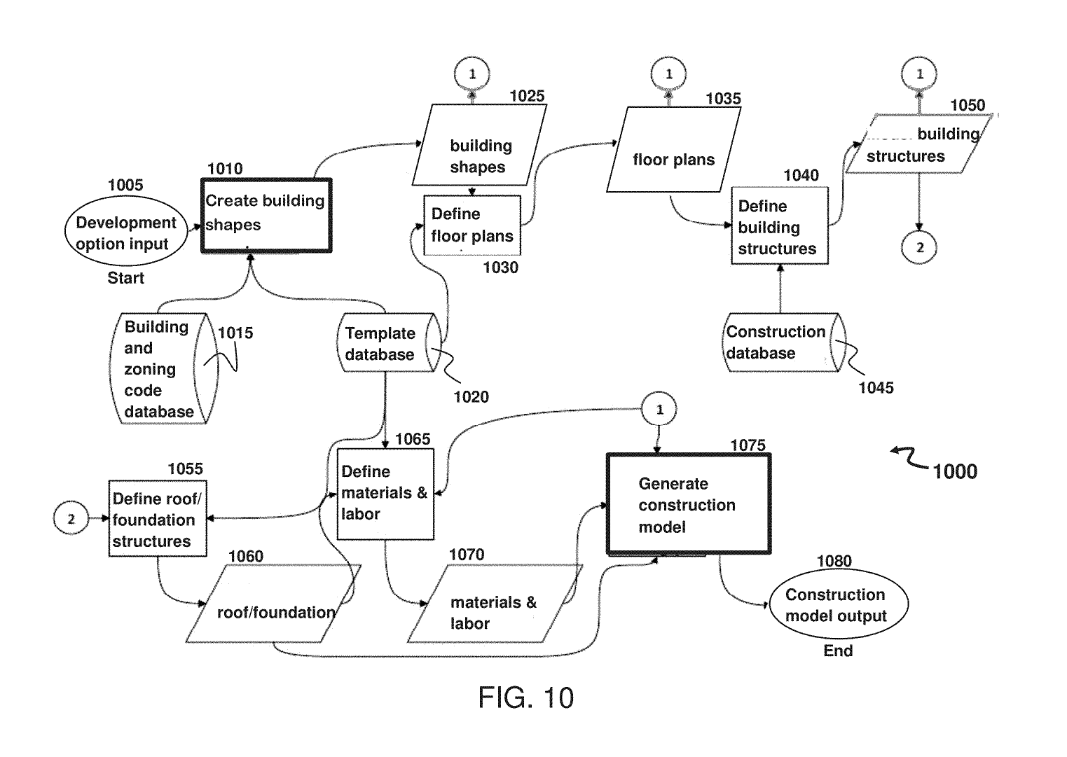

FIG. 10 illustrates the transformation of development option data into a construction model, according to some embodiments. As can be seen, the transformation 1000 of the development option into a respective construction model can be a component approach that includes the input 1005 of a development option which is also referred to as a project option herein. The overall process is to create 1010 each building shape and use these shapes to generate 1075 a respective construction model from the input 1005 of the development option. The transformation steps can include, for example, defining 1030,1040,1055,1065 each component of the development option using data from a respective component database source 1015,1020,1045 in which the respective data can be obtained and defining each construction model component 1025,1035,1050,1060,1070 to generate 1075 and output 1080 the construction model for use in creating a respective optimization model.

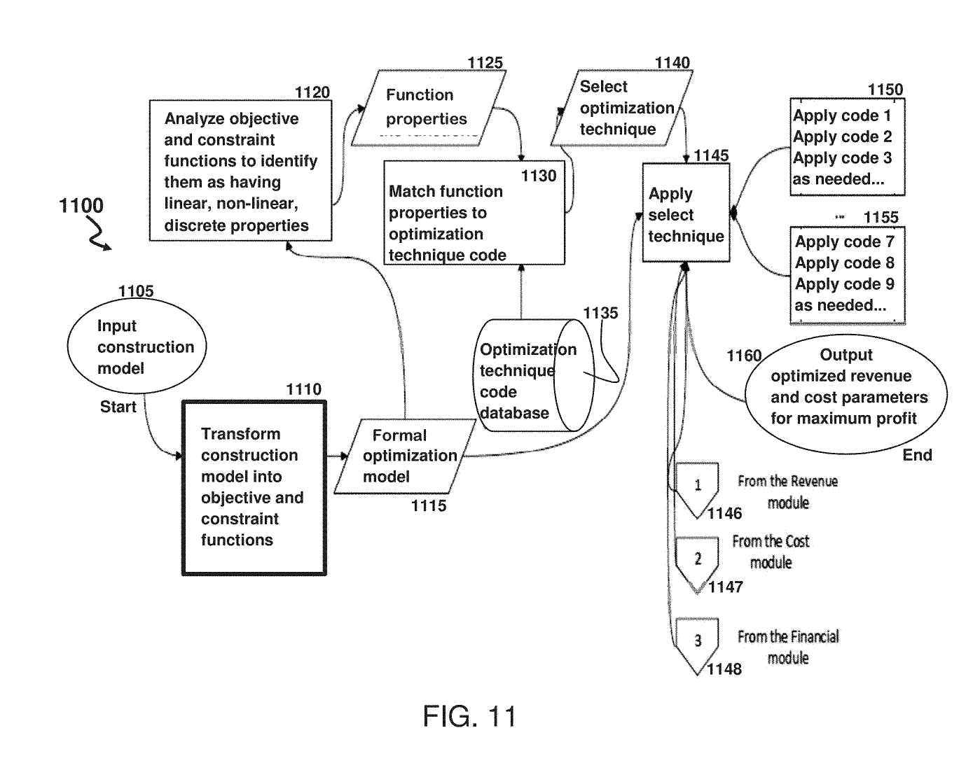

FIG. 11 illustrates the transformation of construction model data into an optimization model, according to some embodiments. As can be seen, the transformation 1100 of the construction model into a respective optimization model includes the input 1105 of a construction model having parameters that are transformed 1110 into a set of functions that have cost-related parameters and revenue-related parameters from the construction model, the set of functions including an objective function and constraint functions, the objective function expressing profit as a function of revenue and development cost, and the optimization of the objective function serving to maximize profit by optimizing the cost-related parameters and the revenue-related parameters. Formalized optimization models 1115 are produced and analyzed 1120 to identify linear, non-linear, and discrete properties of the functions. The function properties 1125 are assigned to the functions, and the function properties 1125 are then matched 1130 to one or more optimization technique codes from an optimization technique database 1135. A select optimization technique 1140 is then applied 1145 in the form of one or more optimization technique codes 1150,1155 using supplemental data 1146 from a revenue module (not shown), supplemental data 1147 from a cost module (not shown), and/or supplemental data 1148 from a financial module (not shown).

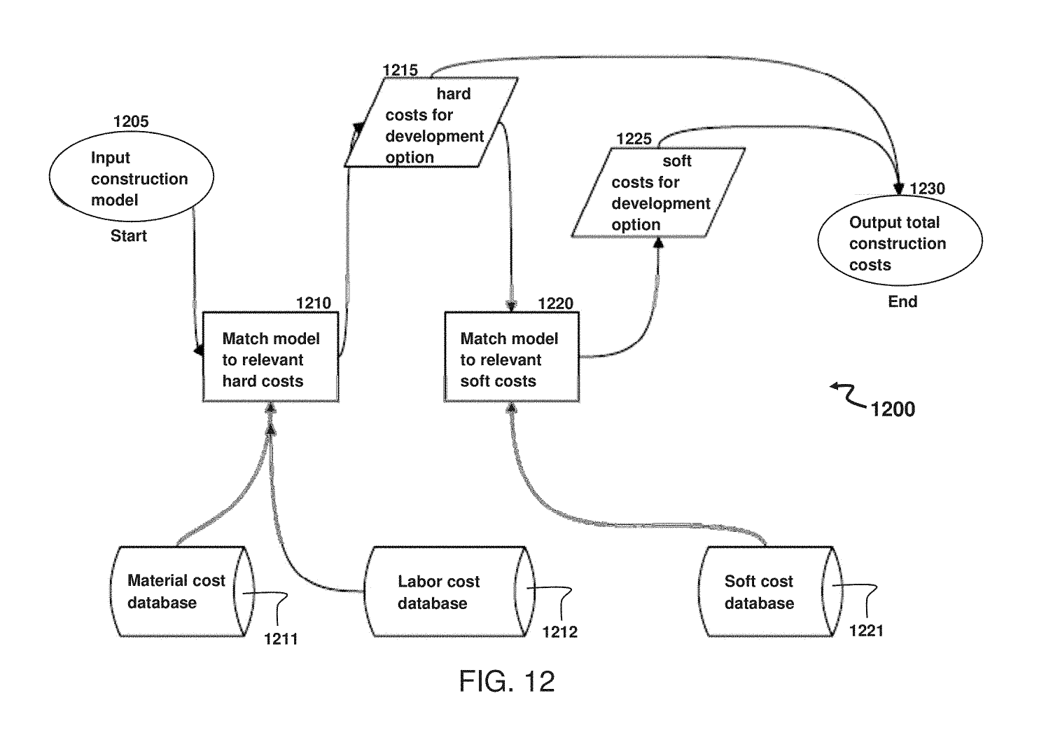

FIG. 12 illustrates a generalized flow of the transformation of construction model data into a total development cost using hard cost data and soft cost data, each which is optimized by the computational optimization engine to optimize revenue, optimize development cost, and maximize profit, according to some embodiments. As can be seen, the transformation 1200 of the construction model input 1205 into a total development cost output 1230 includes matching 1210,1220 the construction model parameters to data in a material cost database 1211, a labor cost database 1212, and a soft cost database 1221. The matching 1210 of the model to the relevant hard costs 1215 calculate a hard cost the development option and, likewise, the matching 1220 of the model to the relevant soft costs 1225 calculate a soft cost for the development option. The combination of the hard cost and soft cost provides a means for calculating the total development cost as an output 1230.

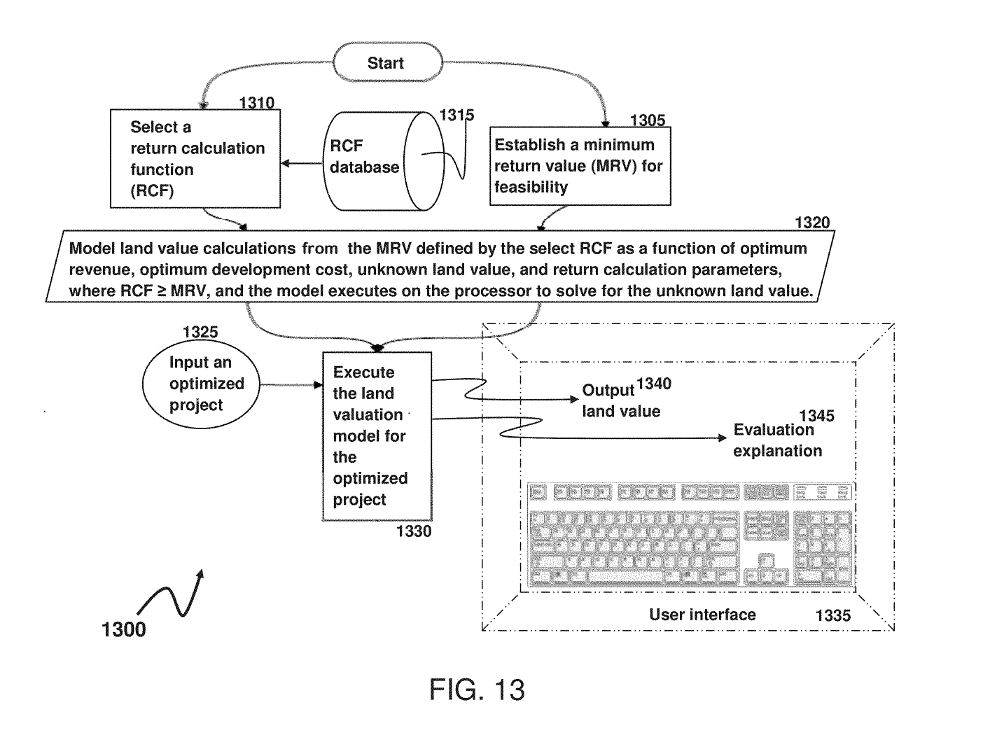

FIG. 13 illustrates a generalized flow of the transformation of the optimized revenue parameters and optimized development cost parameters of an optimized development project into a maximum price that could be paid for a “lot” of land for the project to remain economically feasible, according to some embodiments. As can be seen, the transformation 1300 of the optimized project input 1205 into an output land value 1340 includes establishing 1305 a minimum return value (MRV) that would make the project feasible, and selecting 1310 a return calculation function (RCF) from an RCF database 1315, the RCF selected should represent the manner in which a financial return would ordinarily be measured for such a project, for example, an internal rate of return (IRR) for a bank financing of the project or cash-on-cash for an independent investment on the project. Once the RCF and MRV are selected 1305,1310, the land calculation can be modeled 1320 using the MRV defined by the select RCF as a function of optimum revenue, optimum development cost, unknown land value, and one or more return calculation parameters, where RCF MRV, and the model executes on the processor to solve for the unknown land value as the maximum price that could be paid for the project to remain economically feasible. After the modeling is complete 1320, the model for calculating the maximum land value can be executed 1330 for the optimized project input 1325. A user interface 1335 can then display an output land value 1340 and an evaluation explanation 1345.

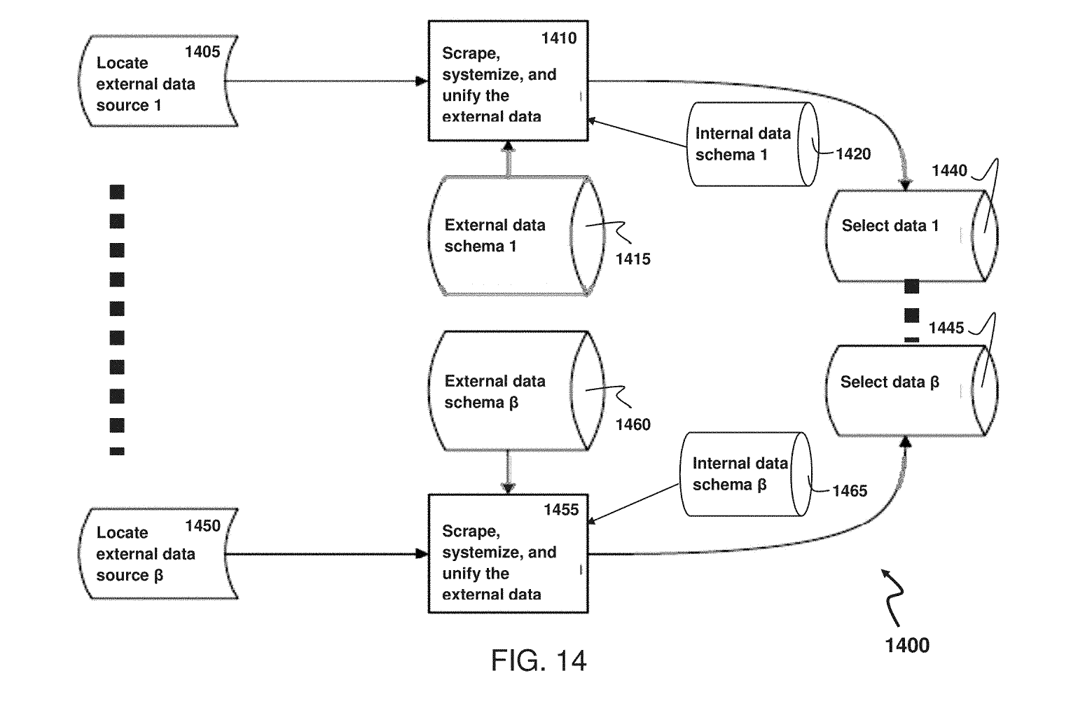

FIG. 14 illustrates a method of gathering and transforming data for use in making and using the systems, and performing the methods, provided herein, according to some embodiments. As can be seen, the gathering 1400 can be structured by identifying a number of external data sources, ranging from 1 to β, wherein β is an integer that represents the total number of external data sources accessed. Once the external data sources are located 1405,1450, the external data sources can be scraped 1410,1455 for information that is needed for making any portion of any component of any system provided herein, or performing any step or combination of steps used in the operation of any method provided herein. The external data, for example, can be derived from any relevant database by scraping the database having an external schema 1415,1460 to fit a select internal schema 1420,1465. A select schema 1420,1465 can be configured, for example, for use in the identification of development options by structuring zoning codes, building codes, or zoning restrictions; in the transformation of a development option into a respective construction model; in the transformation of the construction model into a respective optimization model; and/or, in the valuation of a select, lot of land for a respective development option, to name a few. The select data 1440,1445 are the result of the step of systemizing and unifying 1410,1455 and can be transformed in this manner and compiled in any one or any number of databases as one or more respective master compilations for use by the systems or methods provided herein. In some embodiments, a data translation engine (not shown) can be configured with instructions for execution on a processor for transforming the external data to the one or more master compilations. The transforming can include, for example, the systemizing and/or unifying 1410,1455 of the external data.

One of skill will appreciate that the data desired for executing instructions on a processor for the functions taught herein can be obtained from a wide variety of public and private databases. Moreover, data that may not be accessible for a particular project, location, or point in time, for example, can be supplement by default values or an alternate calculation, each of which can be built-into the systems and methods provided herein. Since the data can come from a variety of sources and can be stored in a variety of database schema, generally speaking, the data will often need to be collected, systemized, and unified for use with the systems and methods provided herein. Much, and perhaps most, of the data can be scraped from available databases. Some data, however, may often require manual entry depending on the sophistication of data storage at a particular location.

The systems and methods provided herein use data relevant to the lot, which might be referred to as a parcel, used in a development project. Any of a variety of websites, such as those offered by planning departments and assessor services can be a source of data for information regarding a select, lot of land, such as an assessor's parcel number (APN) or other general information. Examples of data might include, but are not limited to, APN, use code, description, size of lot, improvements, fixtures, household personal property, business personal property, total taxable value, homeowner information, total net taxable value, mailing address, TRA primary/secondary, land value, CLCA land, CLCA improvement, HOEX, OTEX, last doc date, last doc series, contamination data, air rights, title information, and the like. See, for example, http://www.acgov.org/assessor/maps2.htm (downloaded Apr. 6, 2014). Also, any of a variety of websites, such as those offered by government sources can be a source of data for geodetic information. Examples of data might include, but are not limited to, boundaries and area for a select, lot of land. See, for example, http://www.acgov.org/government/geospatial.htm (downloaded Apr. 6, 2014). Also, any of a variety of websites, such as those offered by government sources can be a source of data for traffic information. Traffic information can be used to assess market value for particular uses, whether residential, commercial, or industrial. Examples of data might include, but are not limited to, population, number of cars per family, household income, employment within the zone, the average value of the car owned per person, and the average number of cars per person. Other parcel data can be considered relevant to the valuation of the land including, but not limited to, historic preservation reports. Also, any of a variety of websites, such as those offered by government sources can be a source of data for such reports. Examples of data might include, but are not limited to, building name, planning department historical status code, national register status code, area plan, area plan rating, information survey, survey rating, heritage register, UMB survey, architectural survey, environmental review data, and the like.

The systems and methods provided herein use data relevant to zoning data. Data on zoning districts can be obtained, for example, from ordinance codification services. Examples of data might include, but are not limited to, common information about the zoning and permitted facilities and activities, such as zone group, name, town, zone name, building types, activities, name, principal/accessory, and type. Data on height and bulk districts can also be obtained from the ordinance codification services. Examples of such data might include, but are not limited to, architectural restrictions, such as minimum/maximum area/length, the relation of the area of a structure to total area, maximum height, density of constructions, zoning on the minimum/maximum area of the lot, minimum width of the lot, maximum non-residential space of the lot, maximum height limit for the facility, minimum required parking, minimum required area, permitted uses, standard yard requirements, and the like. Moreover, data on special zoning districts is also used by the systems and methods provided herein, for example, special uses, special signs, added restrictions on size, design, and type of construction, zoning for street-facing use requirements, limitation name and type. See, for example, http://library.municode.com/index.aspx?clientld=16490 (downloaded Apr. 6, 2014).

The systems and methods provided herein use data relevant to building standards, which might otherwise be referred to as “building codes”, “standards”, or “construction standards”. Examples of data might include, but are not limited to, zoning codes and restrictions, geometric limits on building sizes, sizes of rooms by type of usage, size of inner courts and yards, minimum required light and ventilation, amount of open space required per dwelling unit, fire protection, energy efficiency, and seismic protection, in some embodiments. See, for example, www.bsc.ca.gov/codes.aspx (California Building Standards Commission).

The systems and methods provided herein use economic data including, but not limited to, macroeconomic data, sales/rent data, materials and labor cost data, typical expenses and taxes, financial data. Examples of macroeconomic data might include, but are not limited to, GDP, GRP, and their dynamics by region; employment, unemployment, and their dynamics; expenses by household consumption. See, for example, www.bea.gov (downloaded Apr. 6, 2014), www.bls.gov (downloaded Apr. 6, 2014). Examples of sales/rent data might include, but are not limited to, house prices, rent, types of sales, prices per square foot, and the like. See, for example, http://www.trulia.com/CA/Oakland/(downloaded Apr. 6, 2014). Examples of materials and labor cost data might include, but are not limited to, prices of construction materials and labor, region dependent; See, for example, http://www.indeed.com/salary/q-Constructon-Worker-1-California.html, http://research.stlouisfed.org/fred2/series/M0468BUSM349NNBR (downloaded Apr. 6, 2014), http://enr.construction.com/economics/(downloaded Apr. 6, 2014). In some embodiments, the data can be adjusted for building size, building type, regional differences, etc. Examples of typical expenses and taxes data might include, but are not limited to, maintenance cost for different types of households, information on taxes and fees, cost of permission and other soft costs. See, for example, http://www2.oaklandnet.com/Government/o/CityAdministration/d/EconomicDevelopment/s/M erchantOrganizations/DOWD008100 (downloaded Apr. 6, 2014). Examples of financial data might include, but are not limited to, financing options, mortgage data, loan terms, lending rates, adjustments due to term, size, FICO score, etc. See, for example, http://www.zillow.com/mortgage-rates/ca/oakland/(downloaded Apr. 6, 2014), and http://www.bankrate.com/national-mortgage-rates/(downloaded Apr. 6, 2014).

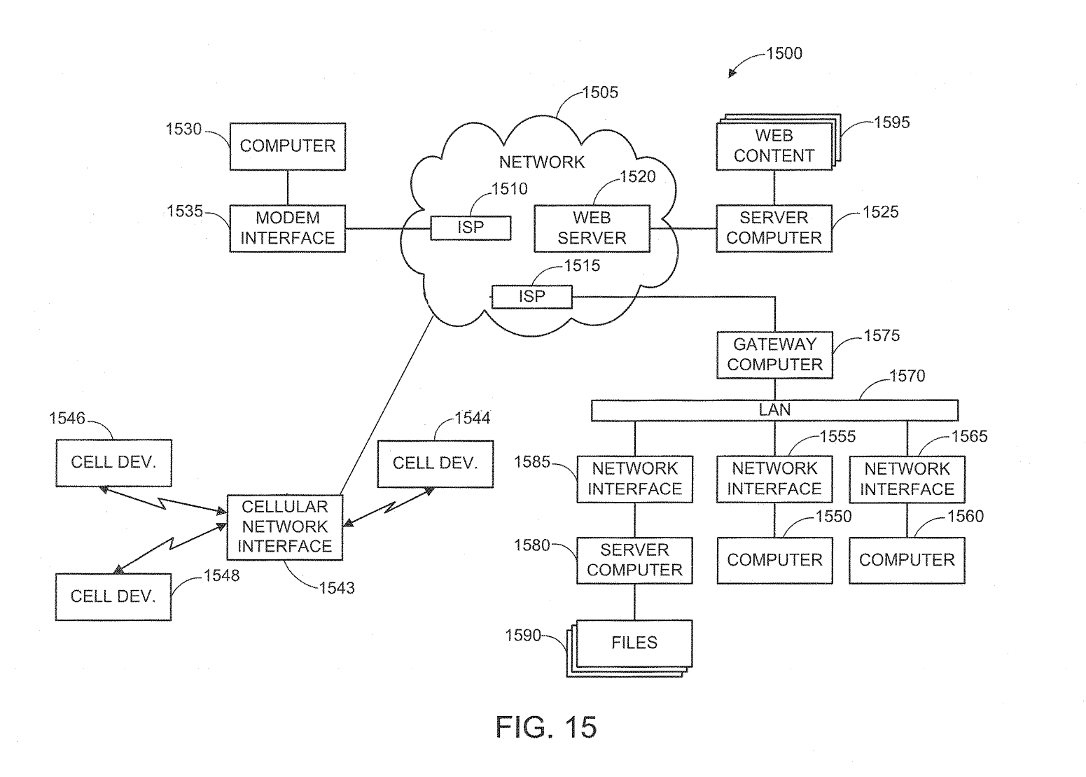

FIG. 15 shows a manner in which the systems and methods are incorporated in a network environment, according to some embodiments. Several computer systems are coupled together through a network 1505, such as the internet, along with a cellular network and related cellular devices. The term “internet” as used herein refers to a network which uses certain protocols, such as the TCP/IP protocol, and possibly other protocols such as the hypertext transfer protocol (HTTP) for hypertext markup language (HTML) documents that make up the world wide web (web). The physical connections of the internet and the protocols and communication procedures of the internet are well known to those of skill in the art. In some embodiments, the network can be a private network. In some embodiments, the network can be a public network. And, in some embodiments, the network can have a combination of public and private access to the network.

As such, access to the internet 1505 can be provided by internet service providers (ISP), such as the ISPs 1510 and 1515. Users of client systems, such as client computer systems 1530, 1550, and 1560 obtain access to the internet through the internet service providers, such as ISPs 1510 and 1515. Access to the internet allows users of the client computer systems to exchange information, receive and send e-mails, and view documents and data, for example, such as documents and data which have been prepared in the HTML format. These documents are often provided by web servers, such as web server 1520 which is considered to be “on” the internet. Often these web servers are provided by the ISPs, such as ISP 1510, although a computer system can be set up and connected to the internet without that system also being an ISP.

The web server 1520 is at least one computer system which operates as a server computer system and is configured to operate with the protocols of the world wide web and is coupled to the internet. Optionally, the web server 1520 can be part of an ISP which provides access to the internet for client systems. The web server 1520 is shown coupled to the server computer system 1525 which itself is coupled to web content 1595, which can be considered a form of a media database. While two computer systems 1520 and 1525 are shown in FIG. 15, the web server system 1520 and the server computer system 1525 can be one computer system having different software components providing the web server functionality and the server functionality provided by the server computer system 1525 which will be described further below. It should be appreciated that any “server” may run as several instances on different computers and, likewise, several servers may run on one physical computer.

Cellular network interface 1543 provides an interface between a radio or cellular network and corresponding radio or cellular devices 1544, 1546 and 1548 on one side, and network 1505 on the other side. Thus cellular devices 1544, 1546 and 1548, which may be any device that can communicate with the network system, including components in the network system, through the cellular network interface 1543, including personal devices including cellular telephones, smart phones, personal digital assistants or other similar devices, may connect with network 1505 and exchange information, which might include HTTP-formatted data, for example. Cellular network interface 1543 is coupled to the network 1505. Data, software, or other such content may then be uploaded or downloaded through the connection provided by interface 1543.

Client computer systems 1530, 1550, and 1560 can each, with the appropriate web browsing software, view HTML pages provided by the web server 1520. The ISP 1510 provides internet connectivity to the client computer system 1530 through the modem interface 1535 which can be considered part of the client computer system 1530. The client computer system can be a personal computer system, a network computer, or other such computer system having a processor and a memory configured in an operable communication with the other computer systems in the network.

Similarly, the ISP 1515 provides internet connectivity for client systems 1550 and 1560, although as shown in FIG. 15, the connections are not the same as for more directly connected computer systems. Client computer systems 1550 and 1560 are part of a LAN coupled through a gateway computer 1575. Interface 1535 can be an analog modem, isdn modem, cable modem, or other interface for coupling a computer system to other computer systems.

Client computer systems 1550 and 1560 are coupled to a LAN 1570 through network interfaces 1555 and 1565, which can be ethernet network or other network interfaces. The LAN 1570 is also coupled to a gateway computer system 1575 which can provide firewall and other internet related services for the local area network. This gateway computer system 1575 is coupled to the ISP 1515 to provide internet connectivity to the client computer systems 1550 and 1560. The gateway computer system 1575 can be a conventional server computer system. Also, the web server system 1520 can be a conventional server computer system. Alternatively, a server computer system 1580 can be directly coupled to the LAN 1570 through a network interface 1585 to provide files 1590 and other services to the clients 1550, 1560, without the need to connect to the internet through the gateway system 1575.

Through the use of such a network, for example, the system can also be configured to offer an element of correspondence between users of the systems and methods provided herein. In some embodiments, the systems and methods can include a social networking feature, whereby users can contact and communicate with other users. In some embodiments, the system can include a messaging module operable to deliver notifications via email, SMS, and other mediums. In some embodiments, the system is accessible through a portable, single unit device and, in some embodiments, the input device, the graphical user interface, or both, is provided through a portable, single unit device. In some embodiments, the portable, single unit device is a hand-held device, such as a smart phone or tablet, for example, an IPHONE, IPAD, or other similar device. In some embodiments, the systems and methods can operate from the server to a user, from the user to a server, from a user to a user, from a user to a plurality of users, comparable to a system that may be used in an MMO environment (massive, multi-user environment), from a user to a server to a user, from a server to a user (or plurality of users) and a teacher (or plurality of teachers), or a server to a plurality of users and a conductor, for example. The interactions can be through real-time users, perhaps available for real-time interaction in a forum that can be either a public, private, semi-private, or member-only chat room; or, not real-time, such as a user environment including text, wavefile, and/or video communications. A blog-type environment, or message room, is an example of an environment that is not real-time.

A real-time environment provides responses to communications within set time constraints, or “deadlines”. Real-time responses, for example, can be provided on the order of milliseconds, and sometimes microseconds, ranging from 0.001 milliseconds to 999 milliseconds, from 0.01 milliseconds to 900 milliseconds, from 0.02 milliseconds to 800 milliseconds, from 0.03 milliseconds to 700 milliseconds, from 0.04 milliseconds to 600 milliseconds, from 0.05 milliseconds to 500 milliseconds, from 0.06 milliseconds to 400 milliseconds, from 0.07 milliseconds to 300 milliseconds, from 0.08 milliseconds to 200 milliseconds, from 0.09 milliseconds to 100 milliseconds, from 0.10 milliseconds to 50 milliseconds, from 1.0 milliseconds to 10 milliseconds, or any range therein in increments of 0.001 millisecond. In some embodiments, the system response occurs without perceivable delay. It should be appreciated that the network can also be configured to provide text and/or audio for real-time messaging, posting of messages, posting of instructional, posting of news or other items of a related interest to the users, and the like.

The following examples are illustrative of the uses of the present teachings. It should be appreciated that the examples are for purposes of illustration and are not to be construed as otherwise limiting to the teachings.

### Example 1. Prior Art—One Lot, Three Uses Compared; Three Predesigns Produce Three Different Land Valuations by Back-Calculation which Vary Tremendously from the Sales Price Based on Comparable Sales

This example shows three real projects designed for use on the same lot using current, state-of-the-art methods. The uses were designed by three different architecture firms and can be seen to provide three dramatically different land values when compared using a back-calculation of the land value based on a single predesign for each use. The land valuation results obtained from each back-calculation were dramatically different, the differences mainly resulting from the development option selected, as well as the manner in which the minimum required return is calculated. The property sold for $2,500,000 in August of 2013, based on a “comparables” valuation method, independent of intended use, and independent of establishing any minimum return needed to make the project feasible. As can be seen below, depending on whether the land is used to develop apartments, condos, or SROs, and depending on how the minimum return needed is calculated, the land value can be seen to vary from a high value of $9,379,312.68 (SRO use; based on IRR; feasible) to a low value of $1,330,000.00 (apartment use; based on cash-on-cash; feasibility questionable). As such, this example shows the importance of the teachings provided herein with regard to determining a land value as it pertains to at least the feasibility of a development project.

### The Lot

The following property was the subject of this example:

Commercial warehouse

1335 Folsom Street

San Francisco, Calif.

The subject property is a commercial warehouse building located at 1335 Folsom Street San Francisco, Calif. The neighborhood is undergoing significant changes, as well as ongoing and planned development. The property was sold in August of 2013 for $2,500,000. The site is zoned for mixed uses and contains a total lot area of 5700 square feet. Due to numerous recent planning code amendments and recently implemented area plans a great deal of knowledge is required to understand the development potential of the site.

### The Development Options

The three architect firms provided the following 3 different designs, each design being for a different type of use:
Design 1—Apartment building: Suggested 6 stories, 27 residential units and no car parking. Building GSF is 25,518 and the construction type is I A.
Design 2—Condominium building: Suggested 6 stories, 22 residential units and 10 car parking. Building GSF is 27,060 and the construction type is III.
Design 3—SRO building: Suggested 7 stories, 67 SRO residential units and no car parking. Building GSF is 31,980 and the construction type is I B.

It is to be appreciated that, with each design option, the development costs, hard costs, soft cost, insurance, etc., and the potential revenue, are expected to be different.

We evaluated the options based on setting a minimum return and selecting a return calculation based on (i) fixed cash on cash and (ii) fixed IRR.

### Analysis—Cash-on-Cash

Table 1 shows the results of the manual calculation. We looked at a fixed cash-on-cash of 115% and discovered that this minimum return suggested that
Design 1—Apartment building: the maximum land price that should be paid for Design 1 should be more than 1,775,434.30.
Design 2—Condominium building: the maximum land price that should be paid for Design 2 should be no more than $5,423,088.94; and,
Design 3—SRO building: the maximum land price that should be paid for Design 3 should be no more than $9,379.312.68.

### Analysis—Internal Rate of Return (IRR)

Using the same calculation but with a fixed IRR of 15%
Design 1—Apartment building: the maximum land price that should be paid for design 1 based on the IRR should be no more than $1,330,000.00;
Design 2—Condominium building: the maximum land price that should be paid for design 2 based on the IRR should be no more than $3,988,500.00; and,
Design 3—SRO building: the maximum land price that should be paid for design 3 based on the IRR should be no more than $7,093,000.00.

See Table 1 for the data and results.

NOTE: Although it is possible to calculate 3 options manually, it is not possible to calculate all of the possible options for designs, referenced at times herein as development schemes, or even a substantial number of all possible options. Moreover, an architect could not possibly draw all such designs due to at least the time limitations of the due diligence process. To calculate such a massive amount of variations we have to use the systems and methods provided herein.

TABLE 1

| | | DESIGN 1-APT | DESIGN 2- | DESIGN 3- |
|---|---|---|---|---|
| Number of stories | | 6 | 6 | 7 |
| Building height | | 65 | 65 | 65 |
| Residential Units | | 27 | 22 | 67 |
| Commercial Units | | 0 | 1500 | 0 |
| Bicycle Parking | | 27 | 22 | 67 |
| Car Parking | | 0 | 10 | 0 |
| Rear Yard | | 1425 | 1170 | 884 |
| Building GSF | | 25518 | 27060 | 31980 |
| Residential NSF | | 15745 | 15910 | 24210 |
| Construction Type | | type I A | type III | type I B |
| Cost/GSF | | $350.00 | $250.00 | $320.00 |
| Hard Cost | | $8,931,300.00 | $6,765,000.00 | $10,233,600.00 |
| Soft Cost | 15% | $1,339,695.00 | $1,014,750.00 | $1,535,040.00 |
| Market Land Cost | | $2,500,000.00 | $2,500,000.00 | $2,500,000.00 |
| Subtotal Cost | | $12,870,995.00 | $10,379,750.00 | $14,368,640.00 |
| Financing Cost | 1.0% | $78,297.73 | $63,090.30 | $87,439.87 |
| Interest (12 months term) | 5.5% | $430,637.49 | $346,996.65 | $480,919.30 |
| Total Cost | | $13,379,930.22 | $10,789,836.95 | $14,936,999.17 |
| Total Cost for | | $13,049,621.00 | $10,515,050.00 | $14,573,312.00 |
| NSF | | 15,745.00 | 15,910.00 | 24,210.00 |
| Sale price per NSF | Rental | $5.50 | $950.00 | $1,000.00 |
| Annual Gross Income | | $1,039,170.00 | | |
| OPEX | 35% | $363,709.50 | | |
| NOI | | $675,460.50 | | |
| cap rate | | 5% | | |
| FV | | $13,509,210.00 | | |
| Total Sale | | $13,509,210.00 | $15,114,500.00 | $24,210,000.00 |
| commission/marketing | 2% | $270,184.20 | $604,580.00 | $968,400.00 |
| Total Income | | $13,239,025.80 | $14,509,920.00 | $23,241,600.00 |
| Gross Profit | | $(140,904.42) | $3,720,083.05 | $8,304,600.83 |
| Equity Multiplier | | | 1.88 | 2.42 |
| Equity | 40% | $5,219,848.40 | $4,206,020.00 | $5,829,324.80 |
| Debt | 60% | $7,829,772.60 | $6,309,030.00 | $8,743,987.20 |
| Total Funds | 100% | $13,049,621.00 | $10,515,050.00 | $14,573,312.00 |
| Cash on Cash | | 15.00% | 15.00% | 15.00% |
| LAND VALUE (CASH) | | $1,775,434.30 | $5,423,088.94 | $9,379,312.68 |
| IRR | | 15.00% | 15.00% | 15.00% |
| LAND VALUE (IRR) | | $1,330,000.00 | $3,988,500.00 | $7,093,000.00 |

Given the above, one of skill will appreciate that the method of using comparable sales prices is highly insufficient in assessing the land value portion of a development project. One of skill will appreciate that a developer, broker, or architect will each likely have different ideas on what is potentially the most viable and appropriate development option for a lot of land, and comparable sales do not take this variable into account. Moreover, even if estimates based on a manual predesign are attempted for a single predesign, the method is inefficient, unpredictable, and does not maximize return or obtain a true maximum value of the land based on revenue generated from, in view of the cost of, a development project. The time available for these analyses is limited and the cost of professional services is high, the combination of which constrain the amount of development that can be elucidated and compared in any given project using current manual predesign methods. Even with unlimited time and funding it would be impossible to come up with an optimized solution manually.

### Example 2. Construction Variables—One Lot, One Use Compared; Three User-Varied Predesigns Produce Three Different Land Valuations by Back-Calculation which Vary Tremendously from the Sales Price Based on Comparable Sales

This example shows how the back-calculation approach results in a variety of land valuations that depend on varying construction parameters to vary the quality of the structure, and thus the business model. The land valuation results obtained from each back-calculation were dramatically different, the differences mainly resulting from the development option selected, as well as the manner in which the minimum required return is calculated.

The construction parameters include, for example, user-specified modifications or variations that often correlate, for example, with an increase in a “per unit” or “per square foot” development cost, exit price, rental price, etc. As the quality of materials or labor costs increase, for example, the relationship between cost and revenue can change. The teachings provided herein can vary these relations to optimize the development potential of the lot used as the building site and, thus, set a maximum price that should be paid for the land for the project in view of an established minimum return required for the project to be considered economically feasible.

The systems and methods provided herein also allow the user to modify the input to customize the output. Different zoning rules such as density, parking requirements, and height limits that are not yet part of the area's zoning can be created and input by the user. For example, this can be done by the user if the user anticipates the possibility of rezoning the site or obtaining a variance as part of the development plan. Other such user-inputted variables may include non-standard pricing on design consultants or added expenses or benefits specific to the user or the potential project.

### The Lot

The following property was the subject of this example:

Commercial warehouse

1335 Folsom Street

San Francisco, Calif.

The subject property is a commercial warehouse building located at 1335 Folsom Street San Francisco, Calif. The neighborhood is undergoing significant changes, as well as ongoing and planned development. The property was sold in August of 2013 for $2,500,000. The site is zoned for mixed uses and contains a total lot area of 5700 square feet. Due to numerous recent planning code amendments and recently implemented area plans a great deal of knowledge is required to understand the development potential of the site.

### The Development Options

Three different development options were analyzed using the back-calculation method.
Design 1—standard SRO construction as per the current zoning ordinance: a base value of $2,500,000 for the land was used, based on the sale price of the lot.
Design 2—a luxury SRO construction: a luxury unit could be sold for a higher price.
Design 3—standard SRO construction and adding one floor to the height of the building, one floor higher than zoning allows: adding a floor results in a slightly reduced development cost due to reduced foundation and roof areas per saleable square foot.

### Analysis—Cash-on-Cash

Table 2 shows the results of the manual calculation. We looked at a cash-on-cash of 141% that corresponds to the actual land cost and Design 1 and discovered that this minimum return suggested that
Design 1—standard SRO construction as per the current zoning ordinance: the base value of $2,500,000 for the land was used, based on the sale price of the lot.
Design 2—a luxury SRO construction: the luxury unit could be sold for the higher price of $1100 per saleable square foot. Using the back-calculation method and taking into account higher development costs, and assuming the same cash-on-cash return, the land value for this option would equate to $3,400,000.
Design 3—standard SRO construction and adding one floor to the height of the building, one floor higher than zoning allows: the extra floor results in a slightly reduced development cost due to reduced foundation and roof areas per saleable square foot. Assuming the same cash-on-cash return, the land value for this option would equate to $3,125,000.

### Analysis—Internal Rate of Return (IRR)

Table 2 shows the results of the manual calculation. We looked at an IRR of 15% as the current market-affordable value and discovered that this minimum return suggested the following:
Design 1—standard SRO construction as per the current zoning ordinance: the maximum land price that should be paid for design 1 based on the IRR should be no more than $7,093,000.00;
Design 2—a luxury SRO construction: the maximum land price that should be paid for design 2 based on the IRR should be no more than $8,438,500.00; and,
Design 3—standard SRO construction and adding one floor to the height of the building, one floor higher than zoning allows: the maximum land price that should be paid for design 3 based on the IRR should be no more than $8,366,000.00.

TABLE 2

| | | DESIGN 1 - STD | DESIGN 2 - LUX | DESIGN 3 - ADD |
|---|---|---|---|---|
| ADDRESS | | 1335 Folsom | 1335 Folsom | 1335 Folsom |
| Number of stories | | 7 | 7 | 8 |
| Building height | | 65 | 65 | 74 |
| Residential Units | | 67 | 67 | 74 |
| Commercial Units | | 0 | 0 | 0 |
| Bicycle Parking | | 67 | 67 | 74 |
| Car Parking | | 0 | 0 | 0 |
| Rear Yard | | 884 | 884 | 884 |
| Building GSF | | 31980 | 31980 | 35846 |
| Residential NSF | | 0 | 24210 | 27300 |
| Construction Type | | type I B | type I B | type I B |
| Cost/GSF | | $320.00 | $335.00 | $315.00 |
| Hard Cost | | $10,233,600.00 | $10,713,300.00 | $11,291,490.00 |
| Soft Cost | 15% | $1,535,040.00 | $1,606,995.00 | $1,693,723.50 |
| Wrap Insurance | 2% | $204,672.00 | $214,266.00 | $225,829.80 |
| Subtotal Cost | | $14,473,312.00 | $15,934,561.00 | $16,336,043.30 |
| Financing Cost | 1.50% | $130,259.81 | $143,411.05 | $147,024.39 |
| Interest (12 months) | 5.5% | $477,619.30 | $525,840.51 | $539,089.43 |
| Total Cost | | $15,081,191.10 | $16,603,812.56 | $17,022,157.12 |
| NSF | | 24,210.00 | 24,210.00 | 27,300.00 |
| Sale price per NSF | | $1,000.00 | $1,100.00 | $1,000.00 |
| Total Sale | | $24,210,000.00 | $26,631,000.00 | $27,300,000.00 |
| commission/marketing | 4% | $968,400.00 | $1,065,240.00 | $1,092,000.00 |
| Total Income | | $23,241,600.00 | $25,565,760.00 | $26,208,000.00 |
| Gross Profit | | $8,160,408.90 | $8,961,947.44 | $9,185,842.88 |
| Equity Multiplier | | 2.41 | 2.41 | 2.41 |
| Equity | 40% | $5,789,324.80 | $6,373,824.40 | $6,534,417.32 |
| Debt | 60% | $8,683,987.20 | $9,560,736.60 | $9,801,625.98 |
| Total Funds | 100% | $14,473,312.00 | $15,934,561.00 | $16,336,043.30 |
| Cash on Cash | | 141% | 141% | 141% |
| LAND VALUE (CASH) | | $2,500,000.00 | $3,400,000.00 | $3,125,000.00 |
| IRR | | 15% | 15% | 15% |
| LAND VALUE (IRR) | | $7,093,000.00 | $8,438,500.00 | $8,366,000.00 |

Given the above, one of skill will appreciate that the method of using comparable sales prices is highly insufficient in assessing the land value portion of a development project. One of skill will appreciate that the construction parameters, even those that exist for a single development option for a lot of land, affect the feasibility of the development project. Comparable sales do not take this variable into account. Moreover, even if estimates based on a manual predesign are attempted for a single predesign, the method is inefficient, unpredictable, and does not maximize return or obtain a true maximum value of the land based on revenue generated from, in view of the cost of, a development project. The time available for these analyses is limited and the cost of professional services is high, the combination of which constrain the amount of development that can be elucidated and compared in any given project using current manual predesign methods. Even with unlimited time and funding it would be impossible to come up with an optimized solution manually.

### Example 3. Similar Properties, Different Development Potential—Two Lots, One Use Compared but Having Different Development Potential; Two Predesigns, Based on Different Development Potential Due to Zoning Differences, Produce Different Land Valuations by Back-Calculation which Vary Tremendously from the Sales Price Based on Comparable Sales

This example shows how the back-calculation approach results in different land valuations between two lots of similar size and located only one block apart. It is shown that the different valuations depend on different development potential due to zoning differences. A back-calculation shows that the land values vary tremendously from the sales price based on comparable sales.

### The Lots

Lot 1:

Non-historic, 1 story commercial building

1335 Folsom Street

San Francisco, Calif.

Lot 1 is a commercial warehouse building, a non-historic structure located at 1335 Folsom Street San Francisco, Calif. The neighborhood is undergoing significant changes, as well as ongoing and planned development. The property was sold in August of 2013 for $2,500,000. The site is zoned for mixed uses and contains a total lot area of 5700 square feet. Due to numerous recent planning code amendments and recently implemented area plans a great deal of knowledge is required to understand the development potential of the site. A 65 foot, 7 story building can be built on this lot having 32,000 square feet in overall size.

Lot 2:

Historic, 2 story commercial building

279 9^{th} Street

San Francisco, Calif.

Lot 2 has a historic 2 story structure that is a bit larger in size than the 1335 Folsom building. The property sold for $2,600,000. And, unlike lot 1, the historic nature of the building on lot 2 will most likely prevent demolition of the building. As such, the façade will need to maintained, and the ceiling heights of the building will limit the number of floors possible. Moreover, set-backs of floors will most likely be required, reducing the potential square footage and the potential profit.

### The Development Options

Two different development options were analyzed using the back-calculation method.
Lot 1—SRO construction: a base value of $2,500,000 for the land was used, based on the sale price of the lot; 65 foot new construction, 7 story building, 32,000 square feet.
Lot 2—SRO construction: 6 story “historic” building, 24,000 square feet, with a 10 foot set-back on floors 3-6.

### Analysis—Cash-on-Cash

Table 3 shows the results of the manual calculation. We looked at a fixed cash-on-cash of 141% and discovered that this minimum return suggested that
Lot 1—SRO construction: the base value of $2,500,000 for the land was used, based on the sale price of the lot.
Lot 2—SRO construction: the historic building is limited to 6 floors and the set-backs on floors 3-6, lowering the square footage available for potential revenue; assuming the same cash-on-cash return, the land value for this option would equate to $1,300,000. (Note, this property sold for double that, at a price of $2,600,000 most likely based on comparable sales with adjustments.)

### Analysis—Internal Rate of Return (IRR)

Table 3 shows the results of the manual calculation. We looked at an IRR of 15% and discovered that this minimum return suggested the following:
Lot 1—SRO construction: the maximum land price that should be paid for design 1 based on the IRR should be no more than $7,093,000.
Lot 2—SRO construction: the maximum land price that should be paid for design 1 based on the IRR should be no more than $4,761,000.

TABLE 3

| | | | LOT 1 | LOT 2 |
|---|---|---|---|---|
| ADDRESS | | | 1335 Folsom | 279 9th street |
| Number of stories | | | 7 | 6 |
| Building height | | | 65 | 65 |
| Residential Units | | | 67 | 50 |
| Commercial Units | | | 0 | 0 |
| Bicycle Parking | | | 67 | 50 |
| Rear Yard | | | 884 | 884 |
| Building GSF | | | 31980 | 24000 |
| Residential NSF | | | 24210 | 18168 |
| Construction Type | | | type I B | type I B |
| Cost/GSF | | | $320.00 | $340.00 |
| Hard Cost | | | $10,233,600.00 | $8,160,000.00 |
| Soft Cost | | 15% | $1,535,040.00 | $1,224,000.00 |
| Wrap Insurance | | 2% | $204,672.00 | $163,200.00 |
| Subtotal Cost | | | $14,473,312.00 | $10,847,200.00 |
| Financing Cost | | 1.50% | $130,259.81 | $97,624.80 |
| Interest (12 months | | 5.5% | $477,619.30 | $357,957.60 |
| Total Cost | | | $15,081,191.10 | $11,302,782.40 |
| NSF | | | 24,210.00 | 18,168.00 |
| Sale price per NSF | | | $1,000.00 | $1,000.00 |
| Total Sale | | | $24,210,000.00 | $18,168,000.00 |
| commission/marketing | 4% | | $968,400.00 | $726,720.00 |
| Total Income | | | $23,241,600.00 | $17,441,280.00 |
| Gross Profit | | | $8,160,408.90 | $6,138,497.60 |
| Equity Multiplier | | | 2.41 | 2.41 |
| Equity | | 40% | $5,789,324.80 | $4,338,880.00 |
| Debt | | 60% | $8,683,987.20 | $6,508,320.00 |
| Total Funds | | 100% | $14,473,312.00 | $10,847,200.00 |
| Cash on Cash | | | 141% | 141% |
| LAND VALUE (CASH) | | | $2,500,000.00 | $1,300,000.00 |
| IRR | | | 15% | 15% |
| LAND VALUE (IRR) | | | $7,093,000.00 | $4,761,000.00 |

Given the above, one of skill will appreciate that the method of using comparable sales prices is highly insufficient in assessing the land value portion of a development project. One of skill will appreciate that the development options available at a particular lot, and between lots, even those that exist between a single development option for each of two lots of land only a block apart, can dramatically affect the feasibility, and thus the land values, between the development projects designed for each of the two lots. Comparable sales do not take this variable into account. Moreover, even if estimates based on a manual predesign are attempted for a single predesign for each of the two lots, the method is inefficient, unpredictable, and does not maximize return or obtain a true maximum value of the land based on revenue generated from, in view of the cost of, a development project. This is because the time available for these analyses is limited and the cost of professional services is high, the combination of which constrain the amount of developments and development schemes that can be elucidated and compared in any given project using current manual predesign methods. Even with unlimited time and funding it would be impossible to come up with an optimized solution manually.

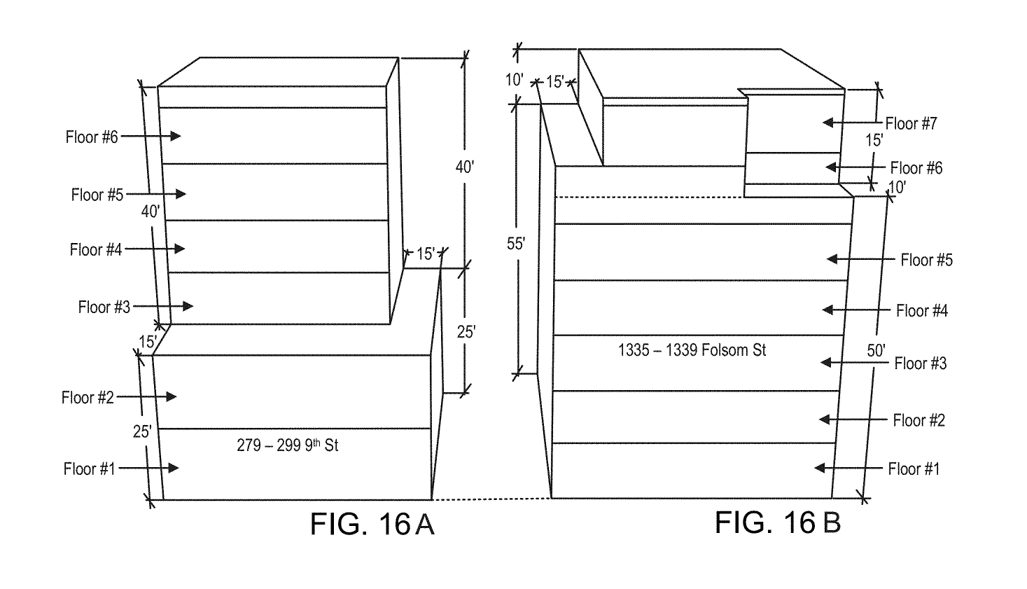

FIGS. 16A and 16B provide an illustration of two building shapes that may be generated by the systems and methods provided herein in the optimization of revenue-related parameters and cost-related parameters, according to some embodiments. These graphical depictions of development options on each of lot 1 and lot 2 take into account zoning codes, building codes, and restrictions, including set-backs. FIG. 16A shows the building shape that may be proposed for lot 2, the historic building at 279 9^{th} St, with the set-backs at floors 3-6; and, FIG. 16B shows the building shape that may be proposed for lot 1, the non-historic building at 1335 Folsom St. As such, the systems and methods provided herein can provide a more accurate land value, since the use of comparables suggest that lot 2 should be worth more, but the systems and methods provided herein will show that, all things considered, lot 2 has less revenue-generating space due to zoning restrictions, and the lot should, therefore, be valued at much less than its sale price of $2,600,000.

### Example 4. User Interface—Point-and-Click Systems and Methods Make Valuations Easy

The computerized systems and computer-implemented methods described herein can have an easy-to-use computer user interface, as shown in this example. The user interface can be configured to display information as graphics, text, audio, and video, for example, as a “drill-down” series of genus, sub-genus, category, sub-category, etc, in some embodiments. This series can also be run in parallel as multiple, simultaneous applications within the systems and methods provided herein. As such, one of skill will appreciate that the information provided can be tiered and/or layered for the user, in series or in parallel.

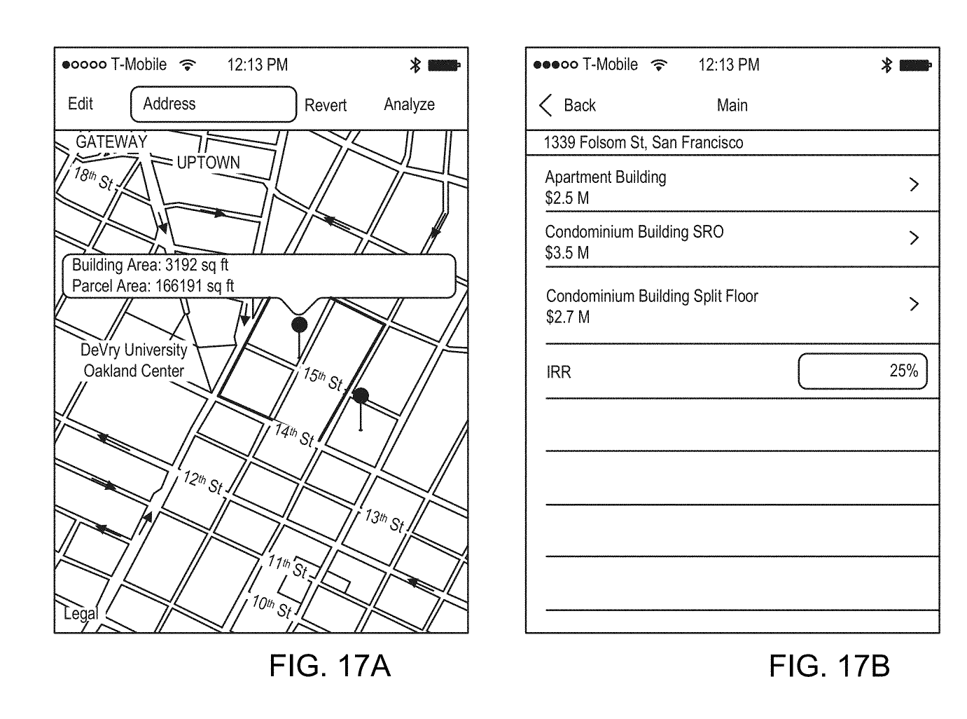

FIGS. 17A and 17B illustrate a user interface that can be used to select a desired “lot” of land for analysis by placing a pin on a parcel, according to some embodiments. FIG. 17A shows how a pin may be placed over a defined parcel or parcels, for example, to obtain a quick overview of building area and parcel area, in some embodiments. FIG. 17B shows how the systems and methods provided herein can use a database having building codes, zoning codes, and zoning restrictions to identify development options and, perhaps, set a minimum return needed for feasibility of a development project, as well as a quick valuation of the maximum amount that should be paid for the lot with respect to each development option in order for the development project to be feasible.

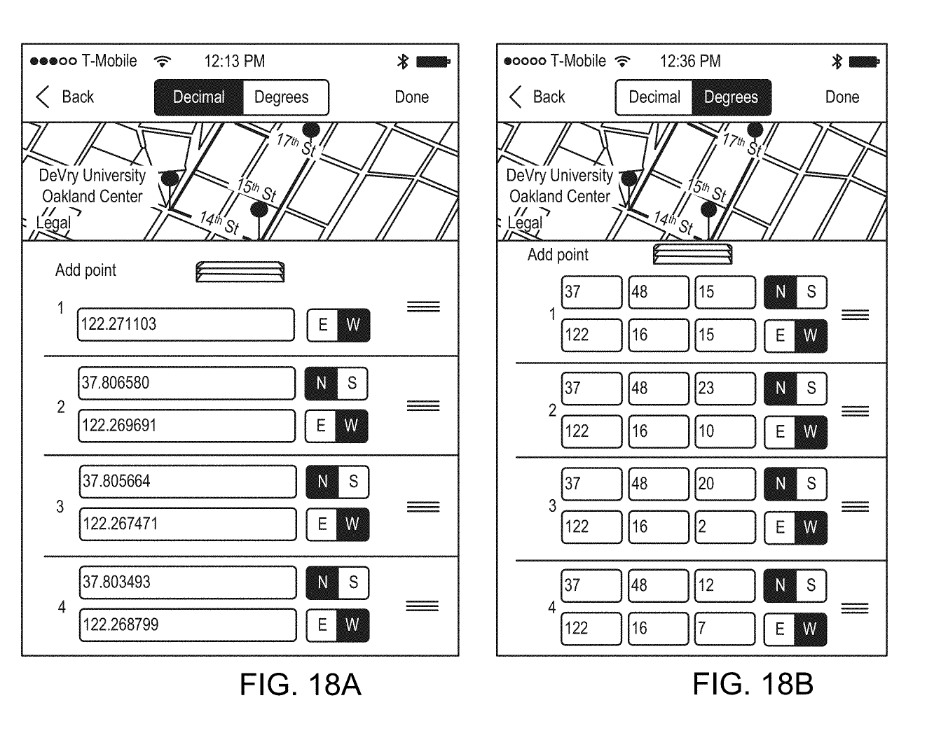

FIGS. 18A and 18B illustrate a user interface that can be used to adjust the selection of a desired “lot” of land, according to some embodiments. In FIGS. 18A and 18B the interface can include placing multiple pins around the lot and adjusting the pin position, or by entering parcel numbers or geographical coordinates in decimal form or degrees, according to some embodiments. As such, the user can click several parcels, or manually select and adjust shape of the parcel or parcels.

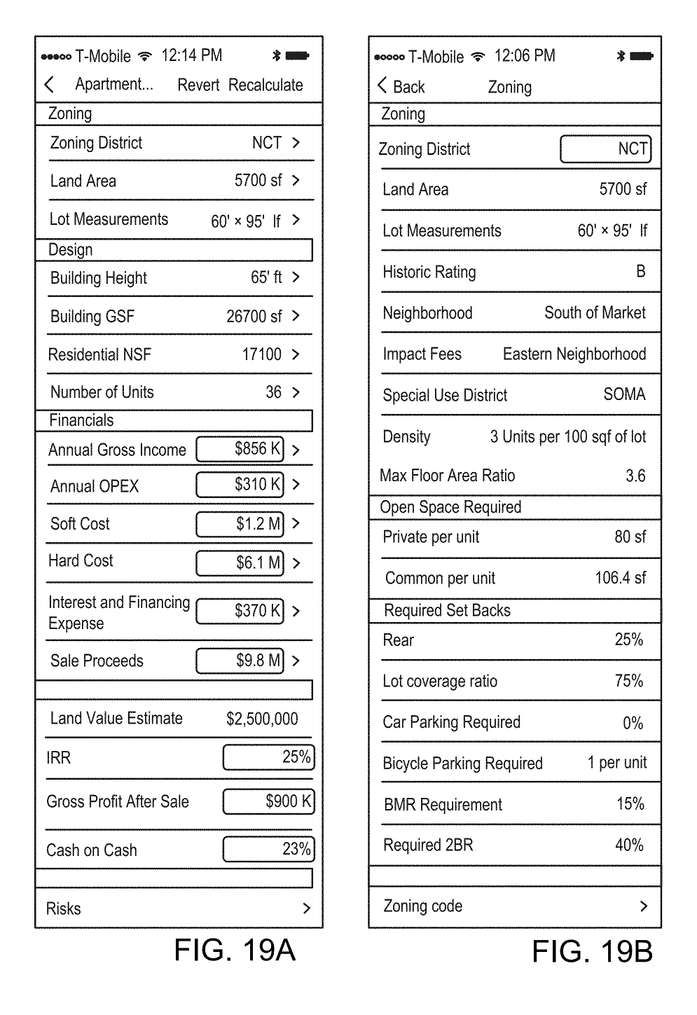

FIGS. 19A and 19B illustrate a drill-down into the analytics provided by the systems and methods provided herein, such as an overview and zoning analytics, for example, according to some embodiments. FIG. 17B illustrated development options with a minimum return needed for feasibility of a development project, as well as a quick valuation of the maximum amount that should be paid for the lot with respect to each development option in order for the development project to be feasible. FIG. 19A is an example of what may be viewed after the user requests more information on the “Apartment” development option by clicking on the option to drill-down for the additional analytics. The analytics in FIG. 19A is representative of the type of information that may be presented in an initial overview of the analytics, whereas FIG. 19B is representative of the type of information that may be presented when drilling-down into the “zoning” analytics, for example.

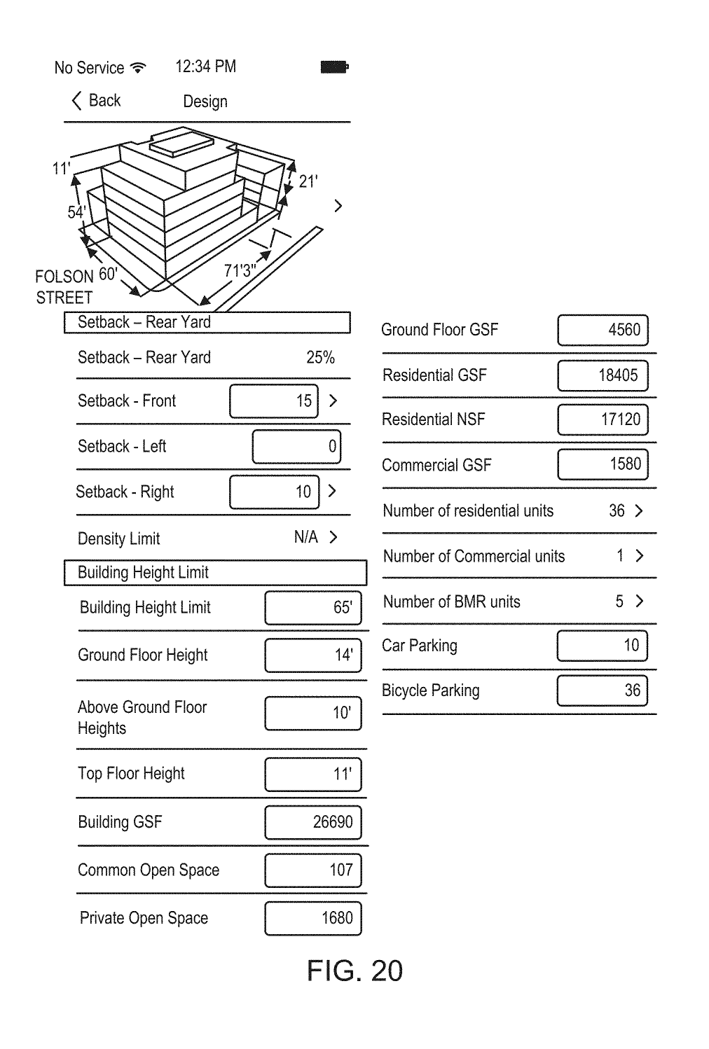

FIG. 20 illustrates a drill-down into the analytics provided by the systems and methods provided herein, such as design analytics, for example, according to some embodiments. The display may provide a graphical depiction of the overall shape with some dimensional parameters, along with a display of data that compose the graphical depiction and additional data that contribute to the revenue, cost, profit, and thus economic feasibility of the development project.

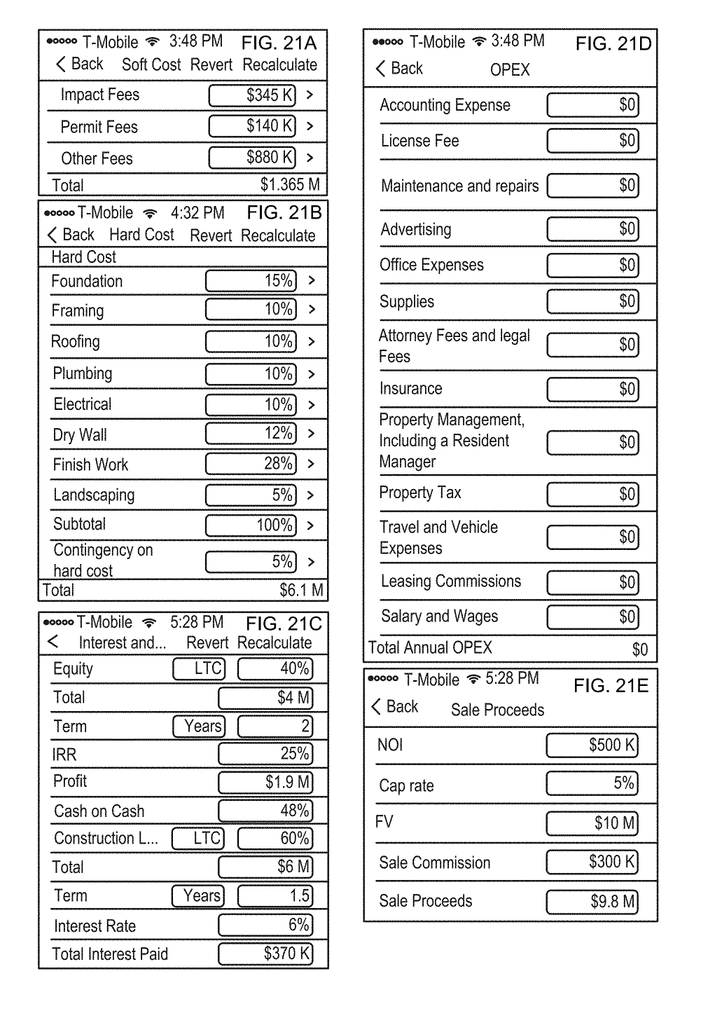

FIGS. 21A-21E illustrate a drill-down into the financial analytics provided by the systems and methods provided herein, such as hard costs, soft costs, financials, operating expenses, and sales process, for example, according to some embodiments. In FIG. 19A, a summary of the financials are presented for a basic understanding of some components contributing to the economic feasibility. FIG. 21A is a drill-down into soft costs, FIG. 21B is a drill-down into hard costs, FIG. 21C is a drill-down into interest and financing expenses, FIG. 21D is a drill-down into operating expenses, and FIG. 21E is a drill-down into sale proceeds. It should be appreciated that the examples provided herein are not intended to be all-inclusive, as such tiered or layered analytics can go much deeper in each category, breaking the analytics down to any resolution desired by the user and/or programmed into the systems or methods by the manufacturer.

In one or more embodiments, all values in the analytics portion of the user interface are selectable and changeable by the user. In one embodiment, when the system detects that the user interacted with the display device displaying the analytics by selecting and changing certain specific value or values, the computerized system is configured to re-do all the above-described calculations and optimizations taking into account user's newly input changes and to re-generate the aforesaid user interface and the analytics in accordance with user's input.

### Example 5. Package Options—a Variety of User Packages can be Offered for Ease of Use in the Field or in the Office

This example describes what one of skill should already appreciate given the teachings provided herein: the systems and methods can be offered as any set or subset of available packages, depending on the processing power possessed by the user. This means that, for example, a smart phone or tablet can be used in the field, which may have less processing power than a computer system available in the user's office environment. Likewise, an office computer system, for example, may have more analytics resident on the computer than the portable, field computer system having less processing power.

One problem with network-based systems is the downtime of the network which can occur with or without notice. A cloud-based application is valuable and useful in that it requires limited resident memory and processing power, but the inevitable down-time of the network can also be inconvenient. To help remedy this issue, the systems and methods provided herein can be offered in a variety of packages. The user's can be, for example:
1. somewhat stand-alone self-sufficient in the office, such that the data needed by the user is updated periodically and, as such, can reside at the user's remote location, accessible during network down-time;
2. partially reliant on a central database in another location, such that the user needs substantial software residing on his remote computer, requiring the uploading and downloading of a modest amount of data upon each use; or,
3. near-completely reliant on the central database in the other location, such that the user may need only a modest amount of software residing on his remote computer, requiring substantial uploading and downloading of data upon each use.

In any event, the user's database can update, such that there is not a total reliance on internet connectivity upon each use. As such, the user can make use of the entire system from a location that is remote from a central server that distributes data, and the reliance on that central server can vary, allowing the user to enjoy the systems and methods provided herein with devices having a wide range of processing power. Given the ability to operate the systems and methods remotely with varying degrees of resident data, the distributor of the systems and methods can license the use of data in various packages: a professional user package that offers and updates commercial, residential, or a combination thereof, for any number of users, geographic locations, duration of time, etc.; or, perhaps, a private package that offers offers and updates commercial, residential, or a combination thereof, for any number of users, geographic locations, duration of time, etc. The following packages are contemplated as user packages that may be desired for more practical applications of the systems and methods provided herein:

OPTION A—In these embodiments, a system or method provided herein can be operated remotely by a computer system having a user interface, a processor, and a memory having instructions for execution through the processor. The instructions can include, for example, a single request for a range of land valuations based on entering a single selection of a “lot” of land at the user interface. As such, the memory might include a modest database capacity for storage and location module. The selection of the lot can include merely clicking on the geographical area of a map, for example. Such embodiments, for example, could establish default values for financial selections that include a “standard” minimum type and amount of return that would make a development project economically feasible to a person of ordinary skill in the art. The output of such a system or method may look a lot like FIGS. 17A and 17B to a user. Such a system or method could be optionally configured to drill-down into the analytics, and perhaps enter user-defined variables, but this would be done through a series of uploads and downloads, such that it is reliant on the network environment for processor power. In these embodiments, the operation of the project module, predesign module, computational optimization engine, revenue module, cost module, and financial module can occur at a central location from which the user is remotely accessing data and processing power.

OPTION B—In these embodiments, the user's remote system includes option A with a project module. The user has more control over the identification of the plurality of development options that are available for analysis, as well as the ability to enter user-defined variables.

OPTION C—In these embodiments, the user's remote system includes option B with a predesign module. The user has more control over the assembly of the construction model for each development option, as well as the ability to enter user-defined variables.

OPTION D—In these embodiments, the user's remote system includes option C with a computational optimization engine. The user has more control over the transformation of the construction model to a respective optimization model for each development option, as well as the ability to enter user-defined variables.

OPTION E—In these embodiments, the user's remote system includes option D with a revenue module, a cost module, a financial module, or some combination thereof. The user has more control over the transformation of the construction model to a respective optimization model for each development option, as well as the ability to enter user-defined variables.

Given the above, an organization can use the systems and methods provided herein in “service tiers”, for example, where any combination of the processor/memory, such as any combination of processor with engine, module, database, etc, taught herein can be combined and offered for a particular use. Since these applications are generally web applications and include mobile applications for internal staff, customers, or both, they can be considered an enterprise application needing access to data, business rules, and business processes. This presents the need for architectural and security planning. These applications can use SOAP-based web services or REST-based web services, for example. In some embodiments, REST-based services can be used with data in JSON format for mobile applications. Examples of such mobile applications include 10S, ANDROID, BLACKBERRY, and MOBILE WEB.

### Example 6. Database Structure—One of a Variety of Database Arrangements for Storing Data Used with the Systems and Methods Provided Herein

This example describes one general arrangement among a variety of database arrangements for storing data used with the systems and methods provided herein. The gathering of data has been generally taught, and this example further provides a logical data structure at a variety of levels: generally, at the level of the user interface, at the level of analytics, automatic testing and continuous integration, infrastructure staging, infrastructure support. The database stores information collected, which will often require systemization and unification for use by the systems and methods provided herein. The database can be any number of servers, and the servers can be at any number of locations. A central server can be used, for example, and the central server can be one or a distribution of servers at one or more locations. For at least these reasons, the description of a particular “database” is merely a term of convenience to describe an data store rather than a literal requirement that the database be an independent structure.

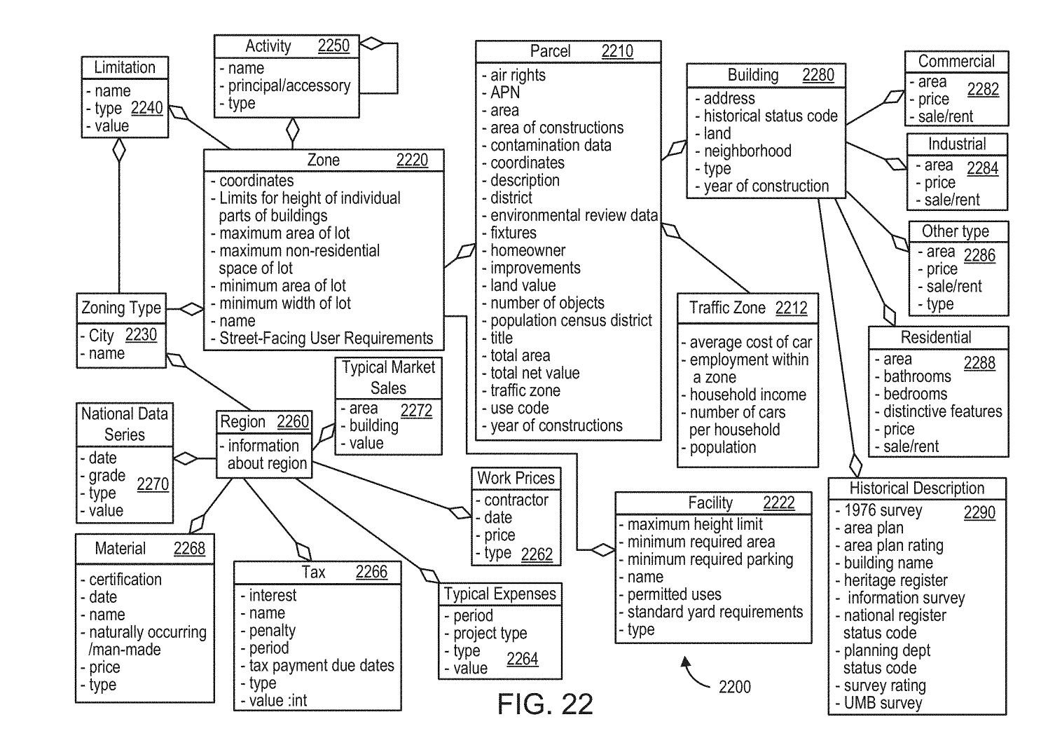

FIG. 22 illustrates general data logic diagram, according to some embodiments. Diagram 2200 is merely a single representation of data interrelationships that can be managed using a database structure. The parcel database 2210 can include, for example, air rights, APN, area, area of construction, contamination data, coordinates, description, district, environmental review data, fixtures, homeowner, improvements, land value, number of objects, population census, district, title, total area, total net value, traffic zone, use code, and year of constructions. The zone database 2220 can include, for example, coordinates, limits for height of individual parts of buildings, maximum area of lot, maximum non-residential space of lot, minimum area of lot, minimum width of lot, name, and street-facing use requirements. The zoning type database 2230 can include, for example, city and name identifiers. The zoning limitations database 2240 can include, for example, name, type, and value identifiers. The zoning activity database 2250 can include, for example, name, principal/accessory, and type identifiers. The data can also be divided into information about a region 2260, such as zoning type 2230 (describe above); typical market sales 2272 expressed as area, building and value identifiers; work/labor prices 2262 expressed as contractor, date, price, and type identifiers; typical expenses 2264 expressed as period, project type, type, and value identifiers; taxes 2266 expressed as interest, name, penalty, period, tax payment due dates, type, and value identifiers; materials 2268 expressed as certification, date name, naturally occurring or man-made, price and type identifiers; and national data 2270 expressed as date, grade, type, and value identifiers. The building database 2280 can include, for example, data expressed as address, historical status code, land, neighborhood, type, and year of construction identifiers. The building database 2280 can be segregated into commercial 2282, industrial 2284, and residential and other types, the data expressed as area, price, type, and sale/rent identifiers, where residential 2288 also includes bathroom, bedroom, and distinctive features identifiers. The building database can also be segregated into a historical description 2290 database having data expressed as 1976 survey, area plan, area plan rating, building name, heritage register, information survey, national register status code, planning department status code, survey rating, and UMB survey identifiers.

At the level of the user interface (UI), the system can support the initial view through a starting window that could contain a map, fields for input of coordinates and a state selector, such as a touch screen or electronic “button” to command the system to execute analysis instructions on the processor to locate a select, lot of land using coordinates which are also used in identifying the development options that are available. A results view shows the estimated cost of land and makes the detailed grounds of the calculation available including, but not limited to, major factors and their influence level on the formation of prices. One or more layered or tiered analyses can be done through additional views by drilling-down to view the specified price, the base of calculation and adjustments which might include, for example, demographics, traffic factors, and the like. In some embodiments, data entry operator will have an interface used to enter some data that cannot be parsed automatically due to logically diverse presentation format, for example. In some embodiments, an assessor will have a user interface to evaluate project estimation and details provided by the application and produce recommendations on improvement of algorithms. In some embodiments, an application developer will have a user interface for application development. In some embodiments, a user interface will be available for internal use for input, modification, and reuse of stored projects. In addition a user interface can be included for specifically view zoning information in a structured manner.

At the level of analytics, the system can support project design by providing data on zoning type and building standards, for example. Types of use can be determined on the basis of this information, and available types of usage are determined, such as a commercial building, residential house, warehouse, etc. For example, if a lot has a zoning code RD-1, in some embodiments, then we can only build detached single family houses. The system can then support the development of a construction model and optimization model for the calculations performed by the systems and methods provided herein. In some embodiments, this may be done by identifying applicable types of usage such as, for example, residential, and project types such as, for example, condo. Then the maximum area of the building can be determined using a variety of construction factors, height limits and reasonable ceiling heights, as well as building size limits, and other limitations imposed by zoning. Common areas, such as staircases, can then be subtracted as a step in deriving a revenue-generating square footage. Knowing the project type and design, revenue can then be calculated. Sales and marketing parameters are used in the calculations, including macroeconomic data and real estate market data which assist in identifying the maximum estimated profit for the each of development options. In some embodiments, a residential house can see a profit from sale or rent, and using real estate market data with the macroeconomic data is a step at identifying potential revenue from purchase/rent, accounting for macroeconomic parameters, such as population employment, available financing, and the like.

The systems and methods can be used to estimate revenue and, in most cases, there are at least two ways of earning revenue: sale and lease. In a residential development, for example, the data of interest can be median home price in the area by type and subtype, whether detached, duplex, condo, apartment for residential, and the like. Median square footage is included in the data of interest. Data affecting median home price includes materials used, such as type of primary wall material including, for example, brick, wood frame, reinforced concrete, and the like.

Assumptions can be used, in some embodiments. For example, an assumption might be that the price per square foot is same for a given type/subtype not depending on the size, and that the type of primary wall material impacts all subtypes in the same way. The assumption facilitates deriving an average price of a housing unit for a given subtype, divided by area of an average unit, multiplied by the area of a given unit, and factoring in given type of primary wall material. All other factors, other than location, type, subtype, square footage, type of wall material, or a combination thereof, might be assumed to be insignificant, in some embodiments. Another assumption is that the unsold inventory can be used as a way to estimate time to sell which can be an indicator of potential revenue.

Many projects will require demolition before development and, as such, the database will provide such data on demolition costs upon receiving the command. The estimation of demolition cost will factor into profit and, thus, the economic feasibility of the project.

In fact, there are a variety of typical costs, including capital costs based on amount, time and rates; administration expenses for implementation of the project; and, the cost of construction materials, labor, duration of the project, cost of building permits, and lending rates. The goal is to identify the significant development costs for an accurate assessment of land value based on economic feasibility. The expenses and revenue are properly discounted at the rate determined as an average capital return in the economy (long-term CAGR of broad stock market index can be used as a good approximation). Probabilities are factored-in as needed.

Other parameters impact revenue that can be realized from the development and are factored-in, such as environmental factors, historical, shade, condition of the soil, pollution, special restrictions, special zoning district, crime situation, and other information such as traffic analyses and demographics that include, but are not limited to, higher mortality, lower birth rate, and negative migration balance.

The systems and methods can also include a corrections mechanism in some embodiments. Such a mechanism can include a feedback loop for correcting the calculated values by correlating actual market prices with the calculated prices to correct for bias, for example. In some embodiments, actual sales prices are located for test properties, and then data on the test properties are processed using the systems and methods provided herein to find the average coefficient of correction. A probability distribution can be used, for example, to determine the fidelity of the method. The distribution can be obtained by plotting, for example, error (x) vs probability of error not being greater than x. Likewise, there can be an assessor feedback loop, in some embodiments, to analyze feedback from assessors.

The system will include automatic functional testing with continuous integration of improvements. Such systematic testing and integration can be included as part of operational support infrastructure, constantly verifying that the system is still working and triggering alerts should the tests fail. Any testing subsystem known to one of skill can be included. The testing system can create an automated repository clone, build, and then deploy of copy using the staging subsystem to run a tests. Results are forwarded in emails, JIRA tickets, and SMS through the support subsystem. The automated tests should cover initially most of the basic application functionality, including comparing calculation results to archived results to detect large changes in estimates indicating possible computational optimization engine issues.

A fixed infrastructure, for example, leased servers in datacenters, can be combined with cloud solutions. Services with a constant heavy usage can run on fixed servers, while variable load services with many IP addresses in different places will run on the cloud, to facilitate scraping of data, for example, for a cost-effective approach.

It should be appreciated that the system will deal with a large quantity of external data from non-cooperative sources having formats which can change, the system will be distributed with sometimes long chains of data acquisition, storage, transformation and delivery. As such, temporary failures are expected to occur, and quick detection and delivery of information is of high importance in recognizing and correcting failures. Each module of the application can have a test input, and various parameters to and from the module will be recorded on a regular basis, such that a set of rules can be written to dictate when to report a system failure. For example, a lack of scraper input for an hour can indicate that the scraper may have been banned, or the data resource is no longer available. Data reported outside of model limits may suggest scraping or calculation mistakes. Lack of users logging on to the system for 10 minutes, for example, may suggest that the front-end of the site is down or dysfunctional. Each such event can be recorded and compared against a set of rules to trigger alerts. JIRA tickets for support can be automatically created and, if necessary, SMS messages can also be sent. As per typical procedures, the ticket can then be elevated to managers to ensure quick response.

Regardless of the particular data structure, the external data will, to a large extent, be used in the assembly of a construction model through the predesign module. A variety of design parameters can be used and include data relevant to the lot used in the development project, such as the coordinates of the land, zoning code, zoning restrictions, and building code. This data is used by the system to identify development options, which can be used to begin establishing a shape for each option, and a construction model to represent construction data for at least a substantial number of development schemes for each of the development options available. The construction model can include a number of foundation parameters which can include excavation, foundation type, drainage, and waterproofing; floor parameters which can include shape, gross square footage (GSF), net square footage (NSF), thickness, framing type, acoustical (sound mitigation), and access panels; wall parameters which can include wall length, wall height, studs, headers, gypsum board, electrical, doors, baseboard, acoustical (sound mitigation), and access panels; exterior wall parameters which can include wall length, wall height, studs, headers, gypsum board, electrical, façade material, shear panel, windows, doors, baseboard, insulation, acoustical (sound mitigation), and access panels; ceiling parameters which can include attachment system to floor deck, gypsum board, electrical, access panels; unit parameters which can include square footage, number and size of bedrooms, number of baths, living rooms, fireplaces; roof parameters which can include type, gutter/downspouts; landscaping parameters which can include area, plants, trees, soil required, irrigation, planters; and building core components which can include elevators, stairs, fire rated corridors, fire sprinklers, bicycle parking, car parking, utility rooms, trash rooms, and lobbies. Data regarding the availability of utilities is also pertinent and can be data used in the systems and methods provided herein, the utilities data including, for example, data regarding access to power, gas, sewer, and water, each of which includes distance from the development project and capacity upgrades.

### Example 7. Optimization—Using Decision Tables or Decision Trees to Match Optimization Models to Optimization Techniques

The computational optimization engine uses a series of functions that includes an objective function OFi, Pi=Ri-DCi, where Pi is a profit margin; and, a series of constraint functions. The optimization includes establishing a defined revenue domain and a defined cost domain, and a series of revenue-related parameters and a series of cost-related parameters from the construction model. And, the optimization includes maximizing the profit margin, Pi, by optimizing the set of revenue-related parameters and the series of cost-related parameters.

The set of revenue-related parameters and the series of cost-related parameters include building design parameters, like linear dimensions, number of floors, unit mix, number and size of rooms for each unit, net square footage (NSF) percentage, number of parking lots, etc. The parameters may be, for example, discrete, or continuous.

The constraint functions describe the relationships among the variables and define the allowable values for the variables. The constraints can include, for example, minimum and maximum heights according to the zoning and building codes, unit mix limits according to the zoning code, floor height limits according to the building/zoning codes, number of elevators depending on linear sizes and number of floors, and the like.

The optimization model can then be tested to determine its properties, for example, (i) the type approximation (linear, quadratic or polynomial, if any) that can be used for each constraint and objective function and (ii) the type (continuous or discrete) of each variable. As the result we have list of variables and functions with characteristics.

An appropriate computational optimization technique is then selected. There are numerous techniques for solving optimization problems, each of which is tailored to a particular type of problem. In some embodiments, we can use non-linear programming methods, mainly iterative methods (like Newton's method, Quasi-Newton method, Finite difference and others), stochastic optimization (like Monte Carlo simulations) and heuristics that can provide approximate solutions to some optimization problems.

A “decision table”, an example of which is shown in Table 4, can then be used to select the computational optimization technique.

TABLE 4

| Optimization model type | | |
|---|---|---|
| Constraints | Objective | Techniques/Solvers |
| Linear | Linear | Simplex-based, PURE LP SOLVERS, |
| | | Exact LP solvers, Stochastic LP Solvers |
| Linear + | Linear | Mixed integer and stochastic LP Solvers |
| discrete | | |
| Nonlinear | Nonlinear | Branch&bound, Geometric programming, |
| | | Estimation of gradients, |
| Nonlinear + | General | Mixed Integer Nonlinear Programming |
| discrete | Nonlinear, | Branch&bound, Dynamic Programming, |
| | | Stochastic Solvers, Iterative |
| | Some special | |
| | cases | |
| | Convex | Special software for convex optimization |
| | Nonsmooth | Sequential Quadratic Programming with |
| | | Gradient Sampling |
| | General | Newton methods |
| | not widely | |
| | behaved | |
| | Expensive to | Evolutionary methods, Complex |
| | calculate, | Optimization Toolbox, heuristics |
| | Complex | |

For each of the techniques, different software tools/libraries are available. Our system may utilize different libraries, and the list is not closed. The computational optimization techniques can change as new libraries come available, and as the systems and methods are improved during operation.

1. A method of constructing a building that comprises computationally optimizing a plurality of development options, the method comprising:
accessing a computer system comprising a processor, a display device, a database, a location module, a project module, a predesign module, a computational optimization engine, a revenue module, a cost module, and a financial module, each of which is stored on a non-transitory computer readable storage medium and operably connected to the processor;
selecting, using the processor, a lot of land with the location module and retrieving a corresponding lot of land information from a lot of land data structure;
identifying, using the processor, the plurality of development options for the lot with the project module; wherein, the identifying comprises:
extracting zoning data from the database for the lot, the zoning data including zoning restrictions;
identifying each development option data structure, Di, in the plurality of development options;
assembling, using the processor, a construction model, CMi, for each Di with the predesign module, wherein the assembling comprises architecting a development scheme substructure of data, (Dx)i, for each Di, the architecting comprising:
creating a list of restriction parameters obtained from the database for each Di, each restriction parameter in the list used in defining a respective (Dx)i;
creating a series of shapes for each Di, the series of shapes composing a respective shape data structure, Si, where a substructure of data, (Sx)i, of the respective shape data structure, Si, defines the shape corresponding to the respective (Dx)i;
creating a series of floor plans for each Si, the series of floor plans composing a respective floor plan data structure, FPi, where a substructure of data, (FPx)i, of the respective floor plan data structure, FPi, defines the floor plan corresponding to the respective (Dx)i;
creating a series of building structures for each Di, the series of building structures composing a respective building structure data structure, BSi, where a substructure of data, (BSx)i, of the respective building structure data structure, BSi, defines the building structure corresponding to the respective (Dx)i; and,
creating a series of construction material and labor lists for each BSi, the series of construction materials and labor lists composing a respective construction materials and labor list data structure, MLi, where a substructure of data, (MLx)i, of the respective materials and labor list data structure, MLi, defines the construction material and labor list corresponding to the respective (Dx)i;
wherein, the CMi is a compilation of the Si, the FPi, the BSi, and the MLi; i is an integer ranging from 1 to I, where I consists of the number of development options in the plurality of development options; and, x is an integer ranging from 10 to X, where X consists of a substantial number of development schemes corresponding to the respective Di;
storing the construction model, CMi, in a construction model data structure;
transforming, using the processor, the CMi into a respective optimization model, OMi, for the respective Di with the computational optimization engine; wherein,
the OMi comprises a series of functions having (i) a series of revenue-related parameters from the CMi generating a total revenue, Ri, over a time, Ti; and, (ii) a series of cost-related parameters from the CMi generating a total development cost, DCi, over the time, Ti; wherein the Ti ranges from 0 to t in months; wherein, the series of functions comprises:
one or more constraint functions, (CFz)i, where z is an integer ranging from 1 to Z, Z including one or more zoning restrictions for the Di; and,
an objective function, OFi, Pi=Ri-DCi, where the Pi is a profit margin;
and,
the transforming comprises:
establishing a defined revenue domain by executing instructions in the revenue module that set a relationship between the total revenue, Ri, and the series of revenue-related parameters from the construction model, CMi, for the respective Di;
establishing a defined cost domain by executing instructions in the cost module that set a relationship between the total development cost, DCi, and, a series of cost-related parameters from the construction model, CMi, for the respective Di;
and,
maximizing the Pi by optimizing (i) the series of revenue-related parameters to identify an Ropti, the optimized Ri for the respective Di; and, (ii) the series of construction-cost-related parameters to identify a DCopti, the optimized DCi for the respective Di; wherein, the optimizing comprises (i) assigning the OMi as a type of mathematical model, the assigning including determining whether the constraint functions, (CFz)i, are linear, non-linear, discrete, or a combination thereof; and, determining whether the objective function, OFi, is linear, non-linear, or discrete; (ii) matching an optimization technique to the type of mathematical model assigned; and, (iii) instructing the computational optimization engine to solve for the Ropti and the DCopti;
storing the optimization model, OMi, in a optimization model data structure;
calculating, using the processor, a land valuation, LVi, with the computational optimization engine for the respective Di; wherein, the calculating comprises:
establishing a minimum return value, MRV, with the financial module; where, the MRV is a measure of financial return defined by a select, return calculation function, RCF, which is a function of the Ropti, the DCopti, the LVi, and an RCPy; where, the RCPy is a set of one or more return calculation parameters for the respective RCF, where y is the number of return calculation parameters in RCP and is an integer ranging from 0 to Y;
selecting the RCF, the selecting including setting the RCPy for use in the RCF;
determining a maximum land value, LVmaxi, for the respective Di, the determining including maximizing the LVi subject to the RCF (the Ropti, the DCopti, the LVi, the RCPy)≧the MRV; where, the LVmaxi is a maximum price to pay for the land to generate the MRV; and,
repeating the determining of LVmaxi for each Di;
assessing, using the processor, the relative values of LVmaxi for each Di and determining a land value for the development of the parcel of land; and,
constructing, using the processor, the development option corresponding to the DCopti, the optimized DCi for the respective development option data structure Di;
generating on the display device, an interactive report comprising the land value for the development of the parcel of land and the development option;
detecting user interaction with the interactive report generated on the display device and, based on the detected user interaction, generating a second interactive report.

2. The method of claim 1, wherein the RCF comprises a cash-on-cash calculation, and the RCPy comprises a leverage ratio based on the DCopti/equity.

3. The method of claim 1, wherein the RCF comprises an internal rate of return calculation, and the RCPy is a null set.

4. The method of claim 1, further comprising adding select data to the database, the adding including accessing a scraping module on the non-transitory computer readable medium, operably connected to the database, and configured with instructions for executing (i) a process of collecting the select data from an external data source, Sn, where n is an integer ranging from 1 to N; and, (ii) a transporting of the select data to the database to compile a compendium of data in the database, wherein the select data is selected from a group consisting of the zoning data, the list of restriction parameters, the shape data, the floor plan data, the building structure data, the materials and labor list data.

5. The method of claim 1, further comprising adding select data to the database, the adding including accessing a scraping module on the non-transitory computer readable medium, operably connected to the database, and configured with instructions for executing (i) a process of collecting the select data from an external data source, Sn, where n is an integer ranging from 1 to N; (ii) a unification of n data protocols; (iii) a systemizing of the select data from the Sn; and, (iv) a transporting of the select data to the database to compile a compendium of systematic data in the database, wherein the select data is selected from a group consisting of the zoning data, the list of restriction parameters, the shape data, the floor plan data, the building structure data, the materials and labor list data.

6. The method of claim 1, further comprising adding market data to the database for execution of instructions by the revenue module.

7. The method of claim 1, further comprising adding financial data to the database for execution of instructions by the financial module.

8. The method of claim 1, further comprising adding cost data to the database for execution of instructions by the cost module.

9. A system for constructing a building that comprises computationally optimizing a plurality of development options, the system comprising:
a processor, a user interface, a database, a location module, a project module, a predesign module, a computational optimization engine, a revenue module, a cost module, and a financial module, each of which is stored on a non-transitory computer readable storage medium, is operably connected to the processor, and has instructions for execution on the processor; wherein,
the location module is configured with instructions for executing a selection of a lot of land to obtain data from the database relevant to the lot;
the project module is configured with instructions for executing an identification of the plurality of development options for the lot; the project module configured with instructions for executing
an extracting of zoning data from the database for the lot, the zoning data including zoning restrictions; and,
an identifying of each development option data structure, Di, in the plurality of development options;
the predesign module is configured with instructions for executing an assembling of a construction model, CMi, for each Di with the predesign module, wherein the assembling comprises architecting a development scheme substructure of data, (Dx)i, for each Di, the architecting including
creating a list of restriction parameters obtained from the database for each Di, each restriction parameter in the list used in defining a respective (Dx)i;
creating a series of shapes for each Di, the series of shapes composing a respective shape data structure, Si, where a substructure of data, (Sx)i, of the respective shape data structure, Si, defines the shape corresponding to the respective (Dx)i;
creating a series of floor plans for each Si, the series of floor plans composing a respective floor plan data structure, FPi, where a substructure of data, (FPx)i, of the respective floor plan data structure, FPi, defines the floor plan corresponding to the respective (Dx)i;
creating a series of building structures for each Di, the series of building structures composing a respective building structure data structure, BSi, where a substructure of data, (BSx)i, of the respective building structure data structure, BSi, defines the building structure corresponding to the respective (Dx)i; and,
creating a series of construction material and labor lists for each BSi, the series of construction materials and labor lists composing a respective construction materials and labor list data structure, MLi, where a substructure of data, (MLx)i, of the respective materials and labor list data structure, MLi, defines the construction material and labor list corresponding to the respective (Dx)i;
wherein, the CMi is a compilation of the Si, the FPi, the BSi, and the MLi; i is an integer ranging from 1 to I, where I consists of the number of development options in the plurality of development options; and, x is an integer ranging from 10 to X, where X consists of a substantial number of development schemes corresponding to the respective Di;
the computational optimization engine is configured with instructions for executing a transforming of the CMi into a respective optimization model, OMi, for the respective Di; wherein,
the OMi is configured to include a series of functions having (i) a series of revenue-related parameters from the CMi generating a total revenue, Ri, over a time, Ti; and, (ii) a series of cost-related parameters from the CMi generating a total development cost, DCi, over the time, Ti; wherein the Ti ranges from 0 to tin months; wherein, the series of functions comprises:
one or more constraint functions, (CFz)i, where z is an integer ranging from 1 to Z, Z including one or more zoning restrictions for Di; and,
an objective function, OFi, Pi=Ri-DCi, where the Pi is a profit margin;
and,
the transforming comprises:
establishing a defined revenue domain by executing instructions in the revenue module that set a relationship between the total revenue, Ri, and the series of revenue-related parameters from the construction model, CMi, for the respective Di;
establishing a defined cost domain by executing instructions in the cost module that set a relationship between the total development cost, DCi, and, a series of cost-related parameters from the construction model, CMi, for the respective Di;
and,
maximizing the Pi by optimizing (i) the series of revenue-related parameters to identify an Ropti, the optimized Ri for the respective Di; and, (ii) the series of construction-cost-related parameters to identify a DCopti, the optimized DCi for the respective Di; wherein, the optimizing comprises: (i) assigning the OMi as a type of mathematical model, the assigning including determining whether the constraint functions, (CFz)i, are linear, non-linear, discrete, or a combination thereof; and, determining whether the objective function, OFi, is linear, non-linear, or discrete; (ii) matching an optimization technique to the type of mathematical model assigned; and, (iii) instructing the computational optimization engine to solve for the Ropti and the DCopti;
wherein,
the computational optimization engine is further configured with instructions for executing a calculating of a land valuation, LVi, with for the respective Di; wherein, the calculating comprises:
establishing a minimum return value, MRV, with the financial module; where, the MRV is a measure of financial return defined by a select, return calculation function, RCF, which is a function of the Ropti, the DCopti, the LVi, and an RCPy; where, RCPy is a set of one or more return calculation parameters for the respective RCF, where y is the number of return calculation parameters in RCP and is an integer ranging from 0 to Y;
selecting the RCF, the selecting including setting the RCPy for use in the RCF;
determining a maximum land value, LVmaxi, for the respective Di, the determining including maximizing the LVi subject to the RCF (the Ropti, the DCopti, the LVi, the RCPy)≧the MRV; where, the LVmaxi is a maximum price to pay for the lot of land to generate the MRV; and,
repeating the determining of the LVmaxi for each Di;
and,
the display device displays an interactive report comprising the LVmaxi for each Di;
wherein the system is used to identify and construct the development option corresponding to the DCopti, the optimized DCi for the respective development option data structure Di.

10. The system of claim 9, wherein the computational optimization engine is further configured to calculate the RCF using a cash-on-cash calculation, and the RCPy comprises a leverage ratio based on the DCopti/equity.

11. The system of claim 9, wherein the computational optimization engine is further configured to calculate RCF using an internal rate of return calculation, and the RCPy is a null set.

12. The system of claim 9, further comprising a scraping module on the non-transitory computer readable medium, operably connected to the database, and configured with instructions for executing (i) a scraping of an external data source, Sn, where n is an integer ranging from 1 to N; and, (ii) a transporting of select data to the database, wherein the select data is selected from a group consisting of the zoning data, the list of restriction parameters, the shape data, the floor plan data, the building structure data, the materials and labor list data.

13. The system of claim 9, further comprising a scraping module on the non-transitory computer readable medium, operably connected to the database, and configured with instructions for executing (i) a scraping of an external data source, Sn, where n is an integer ranging from 1 to N; (ii) a transporting of select data to the database; and, (iii) a systemizing of the data from the Sn to compile a compendium of systematic data in the database, wherein the select data is selected from a group consisting of the zoning data, the list of restriction parameters, the shape data, the floor plan data, the building structure data, the materials and labor list data.

14. The system of claim 9, wherein the revenue module comprises instructions for the execution of market data.

15. The system of claim 9, wherein the financial module comprises instructions for the execution of financial data.

16. The system of claim 9, wherein the cost module comprises instructions for the execution of cost data.

17. A method for creating a system for constructing a building that comprises computationally optimizing a plurality of development options, the method comprising:
assembling a computer system with a processor, a display device, a database, a location module, a project module, a predesign module, an computational optimization engine, a revenue module, a cost module, and a financial module, each of which is stored on a non-transitory computer readable storage medium, is operably connected to the processor, and has instructions for execution on the processor; wherein,
configuring the location module with instructions for executing a selection of a lot of land from the database;
configuring the project module with instructions for executing an identification of the plurality of development options for the lot; the project module configured with instructions for executing
an extracting of zoning data from the database for the lot, the zoning data including zoning restrictions; and,
an identifying of each development option data structure, Di, in the plurality of development options;
configuring the predesign module with instructions for executing an assembling of a construction model, CMi, for each Di with the predesign module, wherein the assembling comprises architecting a development scheme substructure of data, (Dx)i, for each Di, the architecting comprising:
creating a list of restriction parameters obtained from the database for each Di, each restriction parameter in the list used in defining a respective (Dx)i;
creating a series of shapes for each Di, the series of shapes composing a respective shape data structure, Si, where a substructure of data, (Sx)i, of the respective shape data structure, Si, defines the shape corresponding to the respective (Dx)i;
creating a series of floor plans for each Si, the series of floor plans composing a respective floor plan data structure, FPi, where a substructure of data, (FPx)i, of the respective floor plan data structure, FPi, defines the floor plan corresponding to the respective (Dx)i;
creating a series of building structures for each Di, the series of building structures composing a respective building structure data structure, B Si, where a substructure of data, (BSx)i, of the respective building structure data structure, BSi, defines the building structure corresponding to the respective (Dx)i; and,
creating a series of construction material and labor lists for each BSi, the series of construction materials and labor lists composing a respective construction materials and labor list data structure, MLi, where a substructure of data, (MLx)i, of the respective materials and labor list data structure, MLi, defines the construction material and labor list corresponding to the respective (Dx)i;
wherein, CMi is a compilation of the Si, the FPi, the BSi, and the MLi; i is an integer ranging from 1 to I, where I consists of the number of development options in the plurality of development of options; and, x is an integer ranging from 10 to X, where X consists of a substantial number of development schemes corresponding to the respective Di;
storing the construction model, CMi, in a construction model data structure;
configuring the computational optimization engine with instructions for executing a transforming of the CMi into a respective optimization model, OMi, for the respective Di; wherein,
the OMi is configured to include a series of functions having (i) a series of revenue-related parameters from the CMi generating a total revenue, Ri, over a time, Ti; and, (ii) a series of cost-related parameters from the CMi generating a total development cost, DCi, over the time, Ti; wherein the Ti ranges from 0 to tin months; wherein, the series of functions comprises:
one or more constraint functions, (CFz)i, where z is an integer ranging from 1 to Z, Z including one or more zoning restrictions for the Di; and,
an objective function, OFi, Pi=Ri-DCi, where the Pi is a profit margin;
and,
the transforming comprises:
establishing, using the processor, a defined revenue domain by executing instructions in the revenue module that set a relationship between the total revenue, Ri, and the series of revenue-related parameters from the construction model, CMi, for the respective Di;
establishing, using the processor, a defined cost domain by executing instructions in the cost module that set a relationship between the total development cost, DCi, and, a series of cost-related parameters from the construction model, CMi, for the respective Di;
and,
maximizing, using the processor, the Pi by optimizing (i) the series of revenue-related parameters to identify Ropti, the optimized Ri for the respective Di; and, (ii) the series of construction-cost-related parameters to identify DCopti, the optimized DCi for the respective Di; wherein, the optimizing comprises: (i) assigning the OMi as a type of mathematical model, the assigning including determining whether the constraint functions, (CFz)i, are linear, non-linear, discrete, or a combination thereof; and, determining whether the objective function, OFi, is linear, non-linear, or discrete; (ii) matching an optimization technique to the type of mathematical model assigned; and, (iii) instructing the computational optimization engine to solve for Ropti and DCopti;
wherein,
the configuring of the computational optimization engine further comprises a configuring of the computational optimization engine with instructions for executing a calculating of a land valuation, LVi, with for the respective Di; wherein, the calculating comprises:
establishing, using the processor, a minimum return value, MRV, with the financial module; where, the MRV is a measure of financial return defined by a select, return calculation function, RCF, which is a function of Ropti, DCopti, LVi, and RCPy; where, RCPy is a set of one or more return calculation parameters for the respective RCF, where y is the number of return calculation parameters in RCP and is an integer ranging from 0 to Y;
selecting, using the processor, the RCF, the selecting including setting the RCPy for use in the RCF;
determining, using the processor, a maximum land value, LVmaxi, for the respective Di, the determining including maximizing the LVi subject to the RCF (the Ropti, the DCopti, the LVi, the RCPy)≧the MRV; where, the LVmaxi is a maximum price to pay for the lot of land to generate the MRV; and,
repeating, using the processor, the determining of the LVmaxi for each Di;
storing the optimization model, OMi, in a optimization model data structure;
and,
providing an interactive report on the display device operable to display the LVmaxi for each Di; and
detecting user interaction with the interactive report generated on the display device and, based on the detected user interaction, generating a second interactive report.
wherein, the system is created for identifying and constructing the development option corresponding to the DCopti, the optimized DCi for the respective development option data structure Di.

18. The method of claim 17, wherein the configuring of the computational optimization engine further comprises configuring the computational optimization engine to calculate RCF using a cash-on-cash calculation, and the RCPy comprises a leverage ratio based on the DCopti/equity.

19. The method of claim 17, wherein the configuring of the computational optimization engine further comprises configuring the computational optimization engine to calculate RCF using an internal rate of return calculation, and the RCPy is a null set.

20. The method of claim 17, further comprising configuring a scraping module on the non-transitory computer readable medium and operably connected to the database with instructions for executing (i) a scraping of an external data source, Sn, where n is an integer ranging from 1 to N; and, (ii) a transporting of select data to the database, wherein the select data is selected from a group consisting of the zoning data, the list of restriction parameters, the shape data, the floor plan data, the building structure data, the materials and labor list data.

21. The method of claim 17, further comprising configuring a scraping module on the non-transitory computer readable medium and operably connected to the database with instructions for executing (i) a scraping of an external data source, Sn, where n is an integer ranging from 1 to N; (ii) a transporting of select data to the database; and, (iii) a systemizing of the data from the Sn to compile a compendium of systematic data in the database, wherein the select data is selected from a group consisting of the zoning data, the list of restriction parameters, the shape data, the floor plan data, the building structure data, the materials and labor list data.

22. The method of claim 17, further comprising configuring the revenue module with instructions for the execution of market data.

23. The method of claim 17, further comprising configuring the financial module with instructions for the execution of financial data.

24. The method of claim 17, further comprising configuring the cost module with instructions for the execution of cost data.
